(19) United States
(12) Patent Application Publication
(10) Pub. No.: US 2026/0290369 A1
(43) Pub. Date: Sep. 24, 2026

(54) SYSTEM

(71) Applicant: SoftBank Group Corp., Tokyo (JP)

(72) Inventor: Yuta ARUGA, Tokyo (JP)

(73) Assignee: SoftBank Group Corp., Tokyo (JP)

(21) Appl. No.: 19/558,506

(22) Filed: Mar. 6, 2026

(30) Foreign Application Priority Data
Mar. 19, 2025 (JP) 2025-044525

(51) Int. Cl. G10L 21/055; G06F 18/22; G06N 3/0475; G10L 13/08; G10L 15/26; G10L 25/63

(52) U.S. Cl. CPC G10L 21/055; G06F 18/22; G06N 3/0475; G10L 13/08; G10L 15/26; G10L 25/63

(57) ABSTRACT

A system includes a processor that is configured to collect information based on a user request by using an information retrieval means, generate a prompt for instructing a generative AI model to convert the collected information into audio data, and add music and sound effects to the generated audio data.

### CROSS-REFERENCE TO RELATED APPLICATION

This application is based on and claims priority under 35 USC 119 from Japanese Patent Application No. 2025-044525 filed on Mar. 19, 2025, the disclosure of which is incorporated by reference herein.

### BACKGROUND

### Technical Field

The Present Disclosure Relates to a System.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional techniques for providing audio content based on textual or web information require substantial manual work, including selection of relevant information, drafting of scripts, voice recording, and editing of background music and sound effects. As a result, it is difficult to provide timely, personalized, and continuously updated audio content that directly reflects a user's request. Furthermore, existing systems that utilize text-to-speech or simple speech synthesis often lack an integrated mechanism to automatically retrieve information, generate appropriate prompts for generative AI models, and produce fully edited audio content suitable for immediate distribution over digital networks. Therefore, there is a need for a system that can automatically collect information based on a user request, control a generative AI model to convert the information into audio data, and add music and sound effects, and then deliver the edited audio data to a user terminal, thereby reducing manual effort and enabling efficient and flexible generation of audio content.

### SUMMARY

In order to solve the above-described problems, a system is provided comprising a processor, wherein the processor is configured to collect information based on a user request by using an information retrieval means, generate a prompt for instructing a generative AI model to convert the collected information into audio data, and add music and sound effects to the generated audio data. In one aspect, the processor is further configured to input the prompt into the generative AI model and convert the information into the audio data by using a speech synthesis technique. In another aspect, the processor is configured to deliver the edited audio data, to which the music and sound effects have been added, to a terminal of the user through a digital network. By integrating information retrieval, prompt generation for a generative AI model, audio synthesis, and network distribution within a single system, the invention enables automated generation and delivery of edited audio content that reflects the user's request with reduced manual intervention.

The term “system” refers to an apparatus or combination of apparatuses including at least one processor and any associated hardware and software components configured to execute the functions described in the claims.

The term “processor” refers to any device or combination of devices capable of executing instructions, including but not limited to a central processing unit (CPU), a graphics processing unit (GPU), a digital signal processor (DSP), an application-specific integrated circuit (ASIC), or a field-programmable gate array (FPGA).

The term “information retrieval means” refers to any hardware, software, or combination thereof that is configured to acquire information based on a user request, including by performing searches on local databases, remote servers, or external networks such as the Internet.

The term “user request” refers to any input provided by a user to the system, including but not limited to keywords, queries, commands, selections, or preferences that specify the information to be collected or the content to be generated.

The term “information” refers to any data that is collected in response to the user request, including but not limited to text, metadata, articles, documents, web pages, or other content suitable for conversion into audio data.

The term “generative AI model” refers to any artificial intelligence model that is configured to generate outputs based on received inputs, including but not limited to large language models, multimodal models, or other machine learning models capable of generating or transforming content.

The term “prompt” refers to data, including text or structured input, that is generated by the processor and supplied to the generative AI model to instruct the generative AI model to perform a specific task, such as converting the collected information into audio data.

The term “audio data” refers to any digital representation of sound, including but not limited to synthesized speech, music, effects, or combinations thereof, in formats such as PCM, WAV, MP3, or other audio formats.

The term “music” refers to audio content composed of organized sounds such as melodies, harmonies, rhythms, or background tracks that are added to the audio data to enhance the listening experience.

The term “sound effects” refers to audio elements other than speech and music, including but not limited to jingles, transitions, ambient sounds, or other acoustic signals that are added to the audio data for emphasis or atmosphere.

The term “speech synthesis technique” refers to any method or technology for generating speech from non-audio data, including text-to-speech (TTS) systems, neural speech synthesis, or other techniques that produce spoken audio from the information or from outputs of the generative AI model.

The term “edited audio data” refers to audio data that has been processed or modified after initial generation, including the addition of music and sound effects, adjustment of volume levels, or other post-processing to produce a final audio output.

The term “digital network” refers to any communication network that transmits data in digital form, including but not limited to the Internet, mobile networks, local area networks (LANs), wide area networks (WANs), or combinations thereof.

The term “terminal of the user” refers to any electronic device operated directly or indirectly by the user that is capable of receiving and reproducing audio data, including but not limited to smartphones, tablet computers, personal computers, smart speakers, or other network-connected devices.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

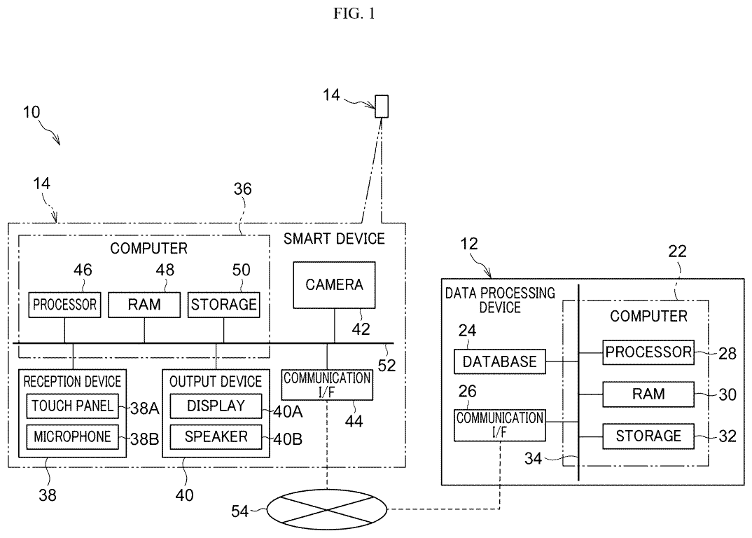

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

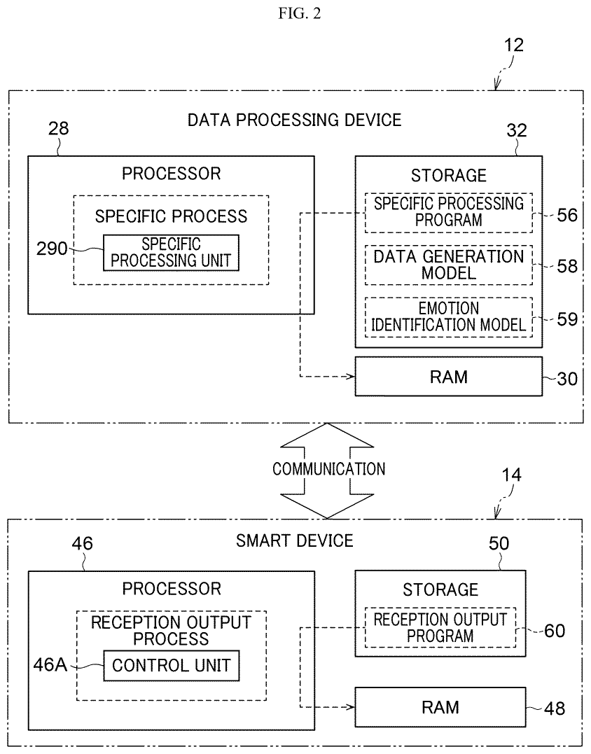

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional content delivery systems that provide spoken versions of text information typically follow a linear pipeline in which text is statically selected, optionally summarized, converted to speech, and then delivered to a user terminal. In many implementations, such processing is hard-coded, rule-based, and detached from any explicit representation of a user's high-level intent. As a result, these systems suffer from several technical limitations: they are not able to efficiently adapt the structure of audio content to different user requests, they do not tightly coordinate information retrieval with script generation, and they perform audio editing in a manner that is decoupled from the semantic structure of the content.

In particular, when a communication apparatus retrieves large volumes of document information from an information network, the apparatus typically processes such information as unstructured text for text-to-speech conversion. Without a mechanism to generate machine-readable instruction information that indicates section boundaries and positions for background sound or sound effects, a processing apparatus must perform additional ad hoc analysis or manual configuration to determine how to segment and augment the audio stream. This leads to increased processing complexity, redundant parsing, and inefficient use of computational resources. It can also result in suboptimal timing and mixing of background sound, causing intelligibility issues and degraded user experience.

Furthermore, known text-to-speech systems generally treat script generation and audio synthesis as independent components. A processing unit commonly receives either raw text or a simple summary and forwards it directly to an audio synthesis engine. In such architectures, there is no explicit integration point where a generative AI model can both (i) produce script information that is structurally aligned with audio editing requirements and (ii) output instruction information indicating insertion positions for background sound data and sound effect data. Because of this lack of integration, conventional systems are not well-suited to automatically generate podcast-like content that is semantically structured and accompanied by precisely timed audio enhancements.

Additionally, existing audio mixing techniques frequently use fixed background sound patterns or generic timing rules that are independent of the generated narration. The processing apparatus often applies uniform volume settings and simple onset offsets, which may cause the background sound to mask important speech segments or to fade at inappropriate times. Without coordinated control based on time information associated with the narration audio data and instruction information linked to content structure, the apparatus cannot reliably determine start and end times, or perform fade-in and fade-out operations, in a way that both preserves speech intelligibility and improves perceptual quality.

Accordingly, there is a need for a technical solution that improves the functioning of a content generation and distribution system by tightly coupling (i) information retrieval from an external information providing apparatus, (ii) generation of script information and instruction information by a generative AI model based on a prompt sentence, and (iii) audio synthesis and editing operations that use such instruction information and time information. Such a solution should reduce the computational overhead of downstream processing, improve the accuracy and automation of timing and mixing control, and enhance the overall efficiency and reliability of generating edited audio data suitable for streaming or download distribution to a user terminal apparatus.

The specific processing by the specific processing unit 290 of the data processing device 12 in Example 1 is realized by the following means.

The present invention provides a server comprising a processor configured to acquire request information from a user via a communication network and generate search condition information including the request information, to transmit a search request to an external information providing apparatus based on the search condition information and to receive and analyze document information to extract article information, to generate a prompt sentence that instructs a generative AI model to convert the article information into script information for audio data and to input the prompt sentence and the article information into the generative AI model to cause the generative AI model to output the script information together with instruction information indicating insertion positions for background sound data and sound effect data, to instruct an audio synthesis apparatus to generate narration audio data from the script information, to generate edited audio data by combining the narration audio data with the background sound data and the sound effect data based on time information associated with the narration audio data and the instruction information including start times, end times, and volume relationships, and to store the edited audio data in a storage apparatus and provide the edited audio data to a utilization terminal apparatus in at least one of a streaming distribution format and a download distribution format. This enables the server to technically improve end-to-end content generation by integrating information retrieval, generative AI-based script and instruction generation, and time-aligned audio mixing in a single coordinated processing pipeline, thereby reducing redundant processing, automatically determining audio insertion timing and volume control, and efficiently producing structurally organized, machine-generated audio content optimized for delivery over a digital network.

The term “processor” refers to a hardware computation unit, or a combination of hardware computation units and control logic, configured to execute instructions and perform data processing operations for implementing the functions of the system.

The term “communication network” refers to a digital communication infrastructure, including wired and wireless links, that enables data transfer between the server, external information providing apparatuses, and utilization terminal apparatuses.

The term “request information” refers to information representing a user's content generation request, including at least a user-specified topic, keyword, or condition for retrieving and generating audio content.

The term “search condition information” refers to structured data generated from the request information and optionally including additional parameters, which is used to form a search request to an external information providing apparatus.

The term “external information providing apparatus” refers to an information processing apparatus or service, accessible via a communication network, that returns document information in response to a search request.

The term “document information” refers to digital information including textual content, and optionally metadata, obtained from the external information providing apparatus in response to the search condition information.

The term “article information” refers to text data, extracted from the document information, that represents the main content relevant to the user's request for use in script generation and subsequent audio processing.

The term “audio output condition information” refers to information specifying output-related conditions for audio content, such as language, tone, style, length, or structural preferences of the generated audio.

The term “generative AI model” refers to a machine learning model that generates text or other content by probabilistically predicting output tokens based on input tokens, and that produces script information and instruction information in response to a prompt sentence.

The term “prompt sentence” refers to text data that specifies a task, conditions, or instructions for the generative AI model, including at least an indication to convert article information into script information for audio data.

The term “script information” refers to structured text data generated by the generative AI model, representing a narrative or dialogue to be spoken in the audio data, and optionally segmented into multiple sections.

The term “configuration conditions” refers to conditions included in the prompt sentence that define structural properties of the script information, such as the number of sections, ordering of content, or presence of introduction and summary parts.

The term “instruction information” refers to data associated with the script information that indicates positions, timings, or other parameters for inserting background sound data or sound effect data into the narration audio data.

The term “audio synthesis apparatus” refers to an apparatus or service that converts text input, such as the script information, into digital audio data using text-to-speech or other audio synthesis techniques.

The term “audio synthesis condition information” refers to information specifying parameters for audio synthesis, such as voice type, language code, speaking rate, pitch, or audio format.

The term “narration audio data” refers to digital audio data representing speech generated from the script information by the audio synthesis apparatus.

The term “background sound data” refers to digital audio data representing non-speech background sounds, including at least background music or ambient audio for use in combination with narration audio data.

The term “sound effect data” refers to digital audio data representing discrete sound effects, such as transitions, signals, or emphasis sounds, for insertion at specified positions relative to the narration audio data.

The term “time information” refers to information associated with the narration audio data or other audio data, indicating temporal positions such as timestamps, durations, start times, and end times used for aligning and mixing audio elements.

The term “volume information” refers to information indicating sound level values or relative gain settings for audio data, used to control loudness during audio mixing and editing.

The term “edited audio data” refers to digital audio data generated by combining the narration audio data with background sound data and sound effect data in accordance with the time information, volume information, and instruction information.

The term “storage apparatus” refers to a hardware storage subsystem, or a combination of storage subsystems, configured to store digital data including the edited audio data for later access or distribution.

The term “utilization terminal apparatus” refers to an end-user device, such as a computing or communication device, configured to receive, decode, and reproduce the edited audio data provided by the server.

The term “streaming distribution format” refers to a data distribution format in which the edited audio data is delivered in a manner that allows playback to begin before all of the audio data is received.

The term “download distribution format” refers to a data distribution format in which the edited audio data is provided for transfer and storage on the utilization terminal apparatus before playback.

The server, the terminal, and the user cooperate to implement embodiments of the present invention as described below. In the following description, the same reference architecture can be realized by various hardware and software platforms; specific examples are provided for clarity and to support enablement, but are not limiting.

The server is a data processing apparatus including at least one processor, a main memory, a non-volatile storage apparatus, and a network interface. The processor can be a general-purpose central processing unit or a combination of a central processing unit and a hardware accelerator, such as a graphics processing unit. The main memory stores executable instructions and runtime data structures for implementing the functions described here. The non-volatile storage apparatus, such as a solid-state drive or a magnetic disk drive, stores program modules, configuration data, and audio data including narration audio data and edited audio data. The network interface connects the server to a communication network, such as the Internet, enabling data exchange with external information providing apparatuses and utilization terminal apparatuses.

The terminal is a user-side computation apparatus, such as a smartphone, a tablet, or a personal computer, having a processor, a memory, a display, an audio output unit, and a communication unit. The terminal executes a browser program or a native application program to send user requests to the server, receive edited audio data from the server, and output the audio data through the audio output unit, such as built-in speakers or headphones. The terminal also presents a user interface that allows the user to input topics, keywords, or other conditions for content generation.

The user operates the terminal to input request information. The request information includes at least a keyword or topic that indicates content of interest, and may further include language preference, desired tone of narration, approximate length of the audio content, and structural preferences such as the number of sections. The terminal associates the request information with a user identifier or session identifier and transmits the request information to the server through the communication network using a network protocol such as Hypertext Transfer Protocol over Transport Layer Security.

The server uses a software execution environment, such as an operating system executed by the processor, and an application framework, such as a web application framework, to implement an information retrieval module, a generative AI interface module, an audio synthesis control module, an audio editing module, and a distribution module. Each module is realized as executable instructions stored in the memory and executed by the processor. The server uses a data store, such as a relational database management system, to store task records that link a request from a user to retrieved document information, generated script information, narration audio data, and edited audio data.

The server generates search condition information from the request information. The search condition information is a structured data object containing fields for a query string, language restriction, date restriction, and other parameters suitable for use with an external information providing apparatus. The external information providing apparatus can be an online information service that exposes an application programming interface to receive search queries and return document information in a structured format, such as a mark-up language or a structured text format.

The server transmits the search condition information to the external information providing apparatus via the communication network, receives document information in response, and stores the received document information in the memory. The server uses a parsing module to analyze the document information. The parsing module executes a sequence of text-processing operations including parsing of mark-up tags, removal of boilerplate regions, and extraction of main content. The server converts the resulting text to article information, which is a normalized internal representation of the textual content, including title strings, body strings, and optional metadata such as publication time and source identifier.

The server then prepares a prompt sentence for a generative AI model. The generative AI model is implemented as a neural network model, such as a transformer-based language model, that has been trained on a large corpus of text data. The server stores model configuration information indicating the number of layers, the number of attention heads, the dimensionality of hidden representations, and tokenization method parameters. The server uses these configuration parameters when connecting to an external model hosting service or executing a local inference engine. The generative AI model operates by receiving input tokens representing the prompt sentence and article information, converting the tokens into vector embeddings, performing multi-head self-attention operations and feedforward transformations, and sequentially generating output tokens representing script information and instruction information.

The server constructs the prompt sentence by concatenating a task description, structural instructions, and article information in a way that is optimized for the generative AI model. The server uses a specific template, such as: “You are an assistant that creates podcast scripts.

Task:

Create a 10-minute podcast script in English that explains the latest technology news in a friendly and clear tone. Structure the script with:
An introduction
Three main news topics with explanations
A short summary at the end

Use the following articles as your source information. Do not copy them verbatim; instead, summarize and explain them.

Articles:
1. Title: [title_1]
   Content: [content_1]
2. Title: [title_2]
   Content: [content_2]”

The server may further embed explicit instructions that require the generative AI model to output section boundaries and markers indicating insertion positions for background sound data and sound effect data. For example, the server can use a template such as: “When you output the script, clearly mark section boundaries as:
[SECTION_START: Introduction]

### [section_start: Topic 1]

. . .
and indicate where background music or sound effects should be inserted using tags such as:
[INSERT_BGM: intro]
[insert_sfx: Transition].”

The server sends the prompt sentence and the article information to the generative AI model as input tokens through a model interface. The server specifies model parameters, such as a sampling temperature that influences generation randomness and a maximum number of tokens for the output. The generative AI model computes intermediate activations at each internal layer. Attention weights are computed over prior tokens to capture contextual dependencies. Output logits are converted into output token probabilities, and tokens are selected according to the specified decoding strategy, such as greedy decoding or beam search.

The server receives the output tokens from the generative AI model and converts them back into text to obtain script information together with instruction information. The script information comprises sectioned text that constitutes a complete narration, and the instruction information comprises explicit tags or markers that specify insertion positions and types of background sound data and sound effect data. Because the generative AI model is configured to follow the prompt structure, the output already aligns content sections with audio editing requirements, thereby reducing the need for separate rule-based analysis and improving computational efficiency.

The server stores the script information and instruction information in data structures associated with the corresponding task. The data structures include a representation of each section, with a section identifier, section text, and associated markers indicating timing relationships or semantic roles. The server then interacts with an audio synthesis apparatus to generate narration audio data from the script information. The audio synthesis apparatus can be a text-to-speech engine that is accessible as an external service or integrated into the server as a software library. The audio synthesis apparatus uses a model such as a neural vocoder-based speech synthesis model that converts phonetic or linguistic features into waveform samples.

The server transmits the script information to the audio synthesis apparatus together with audio synthesis condition information that indicates parameters such as language, voice type, speaking rate, and pitch. The audio synthesis apparatus performs linguistic analysis, converts characters to phonemes, and generates prosodic features such as duration and intonation contours. A synthesis network then generates digital waveform samples representing the narration audio data. The server receives the narration audio data in a compressed or uncompressed audio format and stores it in the storage apparatus.

The server uses the instruction information, which includes markers for background sound insertion and sound effect insertion, to control an audio editing module. The audio editing module is implemented using software libraries such as signal processing libraries that support digital audio mixing, gain control, and envelope shaping. The server retrieves background sound data and sound effect data from a media library stored in the storage apparatus. The media library includes multiple candidate audio tracks categorized by mood, tempo, and length, and multiple sound effect samples categorized by function such as transitions, emphasis, or notifications.

The server uses time information associated with the narration audio data to map the text positions in the script information to time positions along the narration waveform. For example, the server uses alignment data from the audio synthesis apparatus, such as phoneme-level or word-level timestamps, to determine at what time points each section or sentence occurs. The server then uses the instruction information to compute precise start times and end times for each background sound segment and each sound effect segment. The server determines volume information for each track, setting the volume of background sound data lower than that of narration audio data and applying fade-in and fade-out envelopes over predetermined intervals.

The server combines the narration audio data, the background sound data, and the sound effect data in the time domain by computing weighted sums of waveform samples. The server applies normalization or limiting algorithms to prevent clipping and to maintain a desired loudness profile. The server may implement a non-uniform mixing strategy, where background sound is suppressed under high-information speech segments and increased in low-information segments, based on a measure of text importance or per-section emphasis derived from the script information. This technique improves speech intelligibility and listener experience and is implemented through numerical operations performed by the processor, not through ad hoc manual editing.

The server stores the resulting edited audio data in the storage apparatus. The edited audio data is associated with metadata such as duration, file format, and resource locator information. The server uses a distribution module to expose the edited audio data to one or more utilization terminal apparatuses. The distribution module supports at least a streaming distribution format, in which the edited audio data is segmented into chunks and delivered progressively over the communication network, and a download distribution format, in which the full file is transmitted before playback.

The terminal receives the edited audio data or a reference to it, such as a uniform resource identifier, from the server. The terminal uses a media playback component, implemented either through a browser multimedia interface or a native audio playback library, to request the edited audio data and decode it into audio samples. The terminal supplies the decoded audio samples to the audio output unit, which converts the digital samples into analog signals and drives speakers or headphones. The user perceives the content as a podcast-like audio program with structured narration, background music, and sound effects that are temporally aligned with the spoken content.

The server thus implements specific data structures and processing steps that improve computer functionality beyond generic automation of human activity. The server integrates information retrieval, generative AI-based script generation, and audio synthesis and editing in a tightly coupled pipeline. By having the generative AI model produce both script information and instruction information in a machine-parseable structure, the server eliminates previously required heuristic segmentation or manual annotation, reducing computational overhead and memory usage in the editing phase. The server thereby achieves improved throughput for multi-user workloads and reduces latency from user request to availability of edited audio data.

The server configures the generative AI model with a particular prompting strategy and output schema that is designed to support downstream technical processing. The server enforces the schema through validation rules that check for presence of required section tags and insertion markers. This structured output enables the server to implement a deterministic mapping from textual positions to audio operations, improving reproducibility and reducing errors in audio mixing. Because the instruction information is generated according to learned patterns of content structure, the system achieves higher accuracy in timing of background sound and sound effects than simple rule-only systems.

The server may implement multiple alternative embodiments. In one embodiment, the server executes the generative AI model locally on a hardware accelerator. The server loads a trained transformer model from the storage apparatus into the memory, including parameters such as weight matrices for attention and feedforward layers. The server computes an error metric during a fine-tuning phase on training data that includes pairs of article information and desired script and instruction outputs. The server updates model weights by backpropagation to minimize a loss function that combines language modeling loss and annotation accuracy loss. Once trained, the model executes inference by performing matrix multiplications and non-linear transformations on the processor and the hardware accelerator.

In another embodiment, the server calls an external generative AI service. In this case, the server focuses on prompt construction, output validation, and integration with local audio synthesis and editing. The server still uses structured prompts and enforces an explicit output format to support deterministic parsing and alignment. The server can employ different decoding strategies depending on system load or desired diversity, which affects generation speed and network traffic patterns.

In another embodiment, the server applies additional optimization procedures, such as caching retrieved article information for frequently requested topics, or reusing previously generated script segments to avoid redundant model inference. The server uses a cache data structure that maps normalized request information to identifiers of stored script information and edited audio data. This reduces communication load with external information providing apparatuses and with generative AI services, thereby reducing latency and network resource consumption.

In a further embodiment, the server implements adaptive volume control and dynamic range compression based on real-time analysis of narration audio data. The server computes energy profiles and spectral characteristics of the narration and background sound signals and adjusts gain curves accordingly. The server thereby provides improved robustness to variations in playback environment and device capabilities. The technical effect is an improvement in the quality and intelligibility of audio output across different utilization terminal apparatuses without requiring manual engineering for each content item.

The system as a whole is not limited to business workflows or content production procedures. The server uses a precise configuration of data structures, generative models, timing calculation algorithms, and audio mixing controls that together improve how computing resources generate, transform, and deliver audio content. The combination of learned structural output from the generative AI model with deterministic, time-aware mixing logic implemented by the processor results in increased computational efficiency, decreased likelihood of alignment errors, improved audio intelligibility, and enhanced scalability of the content generation pipeline.

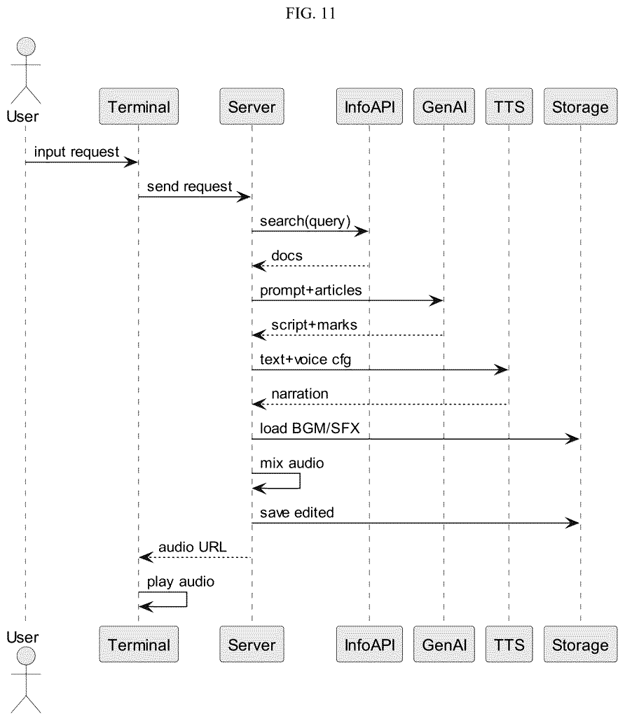

The following describes the processing flow using FIG. 11.

### Step 1

The user operates the terminal to input request information. The user enters a keyword or topic, selects a language and desired tone, and optionally specifies a target duration and number of sections using a graphical user interface. The terminal receives this input as characters and option selections and aggregates them into structured request information. The terminal converts the request information into a data object including at least a topic string, language code, style parameters, and structural preferences, and then transmits this data object to the server over a communication network using a network protocol.

Input: User keystrokes, selection events, and confirmation actions on the terminal.

Output: Structured request information transmitted from the terminal to the server.

### Step 2

The server receives the request information from the terminal. The server parses the received data object, verifies that mandatory fields such as topic and language are present, and assigns a unique task identifier. The server writes a task record to a storage apparatus, recording the task identifier, the request information, and an initial status value. The server thereby converts raw network data into an internal representation suitable for subsequent processing.

Input: Structured request information received over the communication network.

Output: Task record including a task identifier, request information, and initial processing status.

### Step 3

The server generates search condition information based on the request information. The server extracts the topic, language preference, and any time-range constraints from the task record, and maps these fields into a standardized query format compatible with an external information providing apparatus. The server constructs search condition information that includes at least a query string, optional language restrictions, and optional recency filters. The server stores the search condition information in association with the task record.

Input: Task record containing request information.

Output: Search condition information suitable for use in a search request to an external information providing apparatus.

### Step 4

The server transmits a search request to an external information providing apparatus and receives document information in response. The server sends the search condition information using a network interface in the form of a structured query. The external information providing apparatus returns multiple items of document information, each including at least a title, a summary, and a content body. The server receives this response data, decodes any structured encoding, and stores the document information in a temporary memory region linked to the task identifier.

Input: Search condition information.

Output: Document information returned by the external information providing apparatus.

### Step 5

The server analyzes the document information to extract article information. The server uses a parsing module to remove markup, advertisements, and boilerplate from each document, and applies text normalization operations such as character encoding conversion and whitespace normalization. The server then identifies main text segments using predefined rules or statistical heuristics, extracts these as article content, and retains associated titles and metadata. The server encapsulates each processed document as article information including at least title text, main body text, and source information, and stores a list of article information records in association with the task identifier.

Input: Document information containing structured or semi-structured text.

Output: Article information comprising cleaned and normalized text content relevant to the request.

### Step 6

The server constructs a prompt sentence for a generative AI model using the article information and audio output condition information. The server first selects a subset of article information records based on relevance or length thresholds and truncates overly long texts according to model input limits while preserving important sections such as introductions and conclusions. The server then embeds the titles and main body segments into a textual template that describes the generation task, including desired structure (introduction, multiple topics, summary), tone, and length. The server also inserts explicit formatting tags that will be used later as markers for sections and audio insertion points. By concatenating these elements, the server generates a prompt sentence that instructs the generative AI model how to transform the article information into structured script information.

Input: Article information and audio output condition information.

Output: Prompt sentence tailored for the generative AI model, including embedded article content and structural instructions.

### Step 7

The server inputs the prompt sentence and the article information into the generative AI model and obtains script information and instruction information. The server tokenizes the prompt sentence and any appended article text into tokens according to a predefined vocabulary, then sends the tokens to a neural network implementing the generative AI model. Inside the model, matrices representing embeddings, attention weights, and feedforward parameters are multiplied and combined to compute context-aware representations. The model generates output tokens that encode a narrated script divided into sections and containing tags indicating positions for background sound and sound effects. The server decodes the output tokens back into characters and separates the result into script information (section texts) and instruction information (markers for audio insertion). The server validates the presence of required structural tags and stores the script information and instruction information in association with the task identifier.

Input: Prompt sentence and selected article information.

Output: Script information representing structured narration text and instruction information indicating insertion positions for background sound data and sound effect data.

### Step 8

The server prepares audio synthesis condition information and sends the script information to an audio synthesis apparatus. The server derives voice parameters such as language code, voice type, speaking rate, and pitch from the request information and defaults, and constructs a configuration object representing audio synthesis condition information. The server segments the script information into manageable chunks if necessary and transmits each chunk together with the audio synthesis condition information to the audio synthesis apparatus. The server thereby converts high-level textual instructions into detailed parameter settings that control the text-to-speech process.

Input: Script information and user-related audio preferences.

Output: Audio synthesis condition information and corresponding text segments delivered to the audio synthesis apparatus.

### Step 9

The server receives narration audio data from the audio synthesis apparatus. The audio synthesis apparatus processes each text segment through linguistic and acoustic models to produce waveform samples. The server obtains the synthesized audio stream for each segment, decodes or directly stores the audio in a chosen format, and concatenates segments if multiple parts exist. The server associates the resulting narration audio data with timing metadata such as sampling rate, total duration, and any word-level or sentence-level alignment information provided by the synthesis apparatus. The server stores the narration audio data in the storage apparatus and updates the task record to reference the stored location.

Input: Text segments and audio synthesis condition information.

Output: Narration audio data representing synthesized speech corresponding to the script information.

### Step 10

The server selects background sound data and sound effect data based on the instruction information and predefined media library metadata. The server examines instruction tags in the instruction information to determine which types of background music or sound effects are required for each section or insertion point. The server queries a media library index that contains metadata such as mood, tempo, and duration, and selects appropriate audio assets that match the required categories. The server retrieves the selected background sound data and sound effect data files from the storage apparatus into working memory for subsequent mixing operations.

Input: Instruction information and media library metadata.

Output: Selected background sound data and sound effect data loaded into memory for the current task.

### Step 11

The server determines time information and volume information for combining narration audio data with the background sound data and sound effect data. The server uses alignment metadata from the narration audio data, such as timestamps for section starts or sentence boundaries, to map textual markers from the instruction information to precise time positions on the narration timeline. The server calculates start times and end times for each background sound segment and sound effect segment, ensuring that they align with relevant sections of the script. The server also computes initial gain values and volume envelopes, setting background sound levels lower than narration levels and defining fade-in and fade-out curves over predetermined time windows.

Input: Narration audio data with timing metadata and instruction information.

Output: Time information and volume information specifying start and end times and volume profiles for each background and effect track.

### Step 12

The server generates edited audio data by mixing the narration audio data with the background sound data and sound effect data according to the time information and volume information. The server loads all audio tracks into an audio processing buffer, converts them to a common sampling rate and channel count if necessary, and then iterates over time frames to compute blended waveform samples. The server scales each track by its computed gain factor, applies fade-in and fade-out envelopes by multiplying samples with time-dependent weight functions, and sums the samples from different tracks to obtain a combined waveform. The server applies normalization or limiting to avoid clipping and to maintain a target loudness. The resulting waveform is encoded into a digital audio file, which constitutes the edited audio data.

Input: Narration audio data, background sound data, sound effect data, time information, and volume information.

Output: Edited audio data representing a fully mixed audio program with narration, background sound, and sound effects.

### Step 13

The server stores the edited audio data and prepares distribution information for the terminal. The server writes the edited audio data file to the storage apparatus and generates a resource locator, such as a uniform resource identifier, that can be used by the terminal to access the file. The server creates or updates metadata records, including file size, duration, content description, and supported distribution formats. The server then constructs a response object containing at least the resource locator and selected metadata, and sets the task status to indicate that the edited audio data is ready for distribution.

Input: Edited audio data and current task record.

Output: Stored edited audio data, associated metadata, and a resource locator prepared for transmission to the terminal.

### Step 14

The server transmits distribution information to the terminal, and the terminal acquires and plays back the edited audio data. The server sends a response message to the terminal containing the resource locator and playback-related metadata. The terminal receives the response, parses the resource locator, and initiates an audio retrieval request in either streaming mode or download mode. The terminal decodes the received audio data into audio samples using its audio subsystem and outputs the samples through the audio output unit. The user listens to the generated audio content, which reflects the combined results of information retrieval, generative AI-based script generation, and synchronized audio mixing executed by the server.

Input: Resource locator and metadata from the server (at the terminal side).

Output: Audio playback at the terminal, presenting the edited audio data to the user.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

In contemporary network environments, users are required to process a rapidly increasing amount of information delivered over digital communication networks. Conventional content delivery systems typically provide static audio programs or manually produced podcasts, which are created off-line by human editors and voice actors. Such systems are not well suited for dynamically generating audio content that is tailored to an individual user's current topic of interest, preferred language, desired playback duration, or preference regarding background sound, in near real time.

Moreover, conventional systems that merely apply text-to-speech conversion to retrieved documents generally suffer from several technical deficiencies. First, they often perform a simple one-to-one conversion from text to speech without performing structured aggregation, summarization, or narrative arrangement of multiple heterogeneous information sources. This results in redundant, disorganized audio streams that are inefficient to consume. Second, conventional systems lack an integrated control mechanism that optimally coordinates information retrieval, natural-language generation, speech synthesis, and audio editing, and therefore require multiple separate applications or manual intervention, which increases processing latency and resource consumption on servers and terminals.

Further, when attempting to incorporate background music and sound effects into synthesized audio, conventional audio processing pipelines are typically designed for offline production workflows. They do not automatically perform normalized volume control, section-based editing, or programmatic overlay and concatenation in response to user-specific parameters, which leads to unstable sound quality and inconsistent user experience. Additionally, existing streaming and download mechanisms generally treat the generated audio as a generic file and do not tightly couple metadata, content location information, and distribution control with the upstream generation pipeline. This makes it difficult to realize scalable, on-demand, and personalized audio delivery at network scale.

There is therefore a need for a technical mechanism that, within a single server-side processing pipeline, can (i) retrieve topic-dependent information from distributed information sources, (ii) generate structured script text suitable for audio output by using a generative artificial intelligence model under explicit prompt control, (iii) convert the generated script into speech, (iv) programmatically edit and mix the speech with acoustic material data, and (v) register and distribute the resulting audio content via a digital communication path, all while reducing processing complexity, improving throughput, and enhancing the quality and personalization of the delivered audio content. In other words, the technical problem resides in improving computer-implemented information processing and audio content generation so that a server can more efficiently orchestrate heterogeneous software components and network resources to deliver customized audio programs to terminals.

The specific processing by the specific processing unit 290 of the data processing device 12 in Application Example 1 is realized by the following means.

The present invention provides a server comprising a processor configured to (i) acquire topic information transmitted from a terminal based on an operation of a user, generate search conditions based on the topic information, execute an information retrieval process according to the search conditions, and extract text data from a plurality of document data acquired via a network, (ii) generate a prompt sentence, which defines contents, narrative style, structure, and amount of generation processing, on the basis of the extracted text data and the topic information, input the prompt sentence and the text data into a generative information processing model, and cause the generative information processing model to generate script text for audio output, (iii) convert the script text into an audio signal by using a speech synthesis technique, (iv) perform editing processing including adjustment of sound volume level, adjustment of time length, superimposition, and section-by-section concatenation, on the basis of the audio signal and a plurality of acoustic material data stored in a storage device, and generate edited audio data to which background sound and sound effects are added, and (v) add identification information and description information to the edited audio data, register the edited audio data as distribution content, generate response data including location information of the distribution content, and stream-distribute or download-distribute the edited audio data to the terminal via a digital communication path on the basis of the response data. This enables an integrated, computer-implemented pipeline in which the server itself improves information processing efficiency and audio content generation quality by automatically orchestrating information retrieval, generative script creation under prompt control, speech synthesis, and audio editing, thereby reducing latency, lowering processing overhead on the terminal, and providing dynamically customized audio content that is technically optimized for network-based distribution.

The term “topic information” refers to information indicating a subject, keyword, theme, or field of interest specified by a user through a terminal and used as a basis for retrieval and generation of content.

The term “terminal” refers to an information processing apparatus operated by a user, including but not limited to a mobile communication device, a wearable device, or a general-purpose computing device, which is capable of transmitting and receiving data via a digital communication network.

The term “search conditions” refers to parameters derived from topic information, including keywords, time ranges, language constraints, and filtering options, which are used to control an information retrieval process executed over one or more information sources.

The term “information retrieval process” refers to a sequence of computer-implemented operations for querying one or more data sources via a network based on search conditions and acquiring document data that are relevant to the search conditions.

The term “document data” refers to digital data structures representing information items obtained from data sources, including text pages, articles, records, or other content, which are retrievable and processable by a computer system.

The term “text data” refers to character-based information extracted from document data, including natural language sentences, paragraphs, and metadata, that can be further used for natural language processing and generation.

The term “generative information processing model” refers to a machine-implemented model, such as a neural network-based generative artificial intelligence model, that receives input data including a prompt sentence and text data, and outputs generated natural language text in accordance with the input.

The term “prompt sentence” refers to control information expressed as one or more natural language sentences or structured text, which specifies instructions, constraints, style, structure, and amount of content to be produced by a generative information processing model.

The term “script text” refers to generated text data structured as a narrative suitable for audio output, including introductions, main sections, and conclusions, which is intended to be converted into a speech signal.

The term “audio signal” refers to time-varying data representing sound, including encoded or unencoded digital audio samples, which are produced by a speech synthesis technique from script text.

The term “speech synthesis technique” refers to a computer-implemented process or algorithm for converting text data into an audio signal that represents spoken language, including but not limited to text-to-speech conversion.

The term “acoustic material data” refers to pre-stored digital audio resources other than the audio signal generated from the script text, including background music, sound effects, jingles, and other non-speech sound elements.

The term “editing processing” refers to audio processing operations performed on one or more audio signals, including adjustment of sound volume level, adjustment of time length, superimposition of multiple audio tracks, and concatenation of audio segments in a section-by-section manner.

The term “edited audio data” refers to audio data obtained as a result of editing processing applied to the audio signal and acoustic material data, in which background sound and sound effects have been integrated to form a composite audio content item.

The term “identification information” refers to information that uniquely or distinctively identifies a piece of edited audio data or distribution content, including an identifier, index, or other machine-readable reference.

The term “description information” refers to metadata associated with edited audio data or distribution content, including title, summary, topic, language, creation time, and other explanatory attributes.

The term “distribution content” refers to edited audio data together with associated identification information and description information, which is registered and managed as a unit for delivery to one or more terminals.

The term “response data” refers to data generated by the server in response to a request from a terminal, including at least location information of distribution content and optionally additional metadata used for playback or management.

The term “location information” refers to information indicating where distribution content is stored or accessible within a networked system, including a uniform resource identifier, path, or address used to obtain the content.

The term “digital communication path” refers to a logical or physical communication route implemented via one or more networks, through which digital data are transmitted between the server and the terminal.

The term “content delivery infrastructure” refers to a network-connected system or platform configured to store, manage, and deliver content to terminals, including servers, storage devices, and associated control software.

The term “distribution management apparatus” refers to a computing entity or system that manages registration, cataloging, and delivery control of distribution content within a content delivery infrastructure.

The term “distribution control interface” refers to an application programming interface or protocol through which the server issues control requests, including registration, update, or delivery requests, to the content delivery infrastructure.

The term “progressive delivery” refers to a delivery mode in which edited audio data are transmitted in portions responsive to a playback request from a terminal, allowing streaming playback before all audio data have been completely transmitted.

The term “playback time information” refers to information specifying a desired duration or time length of audio playback for generated content, which is used to control the length of the script text and the corresponding audio signal.

The term “setting information regarding presence or absence of background sound” refers to configuration data indicating whether background music or other non-speech audio elements should be included or excluded in the edited audio data.

The term “language information” refers to information specifying one or more natural languages or language variants in which script text and corresponding audio output are to be generated.

In one embodiment, a server cooperates with one or more terminals operated by users to generate, edit, and deliver customized audio content over a digital communication network. The server includes at least one processor, a main memory, a non-volatile storage device, and a network interface coupled via a system bus. The terminal includes a processor, a memory, an audio output device such as a loudspeaker or earphones, and a wireless or wired communication interface. The server and the terminal communicate over a packet-switched network, such as the Internet, using secure communication protocols.

The server executes an operating system and multiple software modules including a web application framework, an information retrieval engine, a generative AI model client library, a speech synthesis client library, and an audio editing library. The web application framework may be implemented by a general-purpose server framework and exposes application programming interfaces to the terminal. The information retrieval engine interacts with external search services and content servers to obtain document data. The generative AI model client library interacts with a generative AI model hosted on an accelerator-equipped computing system. The speech synthesis client library interacts with a text-to-speech engine provided as a network service. The audio editing library utilizes a multimedia processing backend to operate on audio data.

The terminal executes an application that provides a graphical user interface to the user. The user specifies topic information such as “latest technology news” or “artificial intelligence in healthcare” by entering natural language text or by selecting predefined categories. The terminal transmits the topic information, along with language preferences, desired playback duration, and background sound settings, to the server. The terminal does not perform complex content generation; instead, it mainly performs display control, network communication, and audio playback. As a result, computationally intensive processing is centralized at the server, which allows efficient utilization of hardware resources such as graphics processing units and large-capacity storage.

The server stores topic information, user preferences, and processing states in structured data records. For example, the server stores each request as a record that includes a user identifier, topic string, language code, target duration value, background sound flag, and processing status. The server associates these records with retrieval results, generated script text, and generated audio data using relational keys or document identifiers. This structured data management allows the server to cache intermediate results, resume interrupted processing, and reuse common data, thereby reducing redundant computation and network traffic.

The server uses the information retrieval engine to obtain document data relevant to the topic information. The server generates search conditions by transforming the topic string into one or more query expressions, adding filters such as publication time range, source type, and language constraints. The server transmits these search conditions to one or more external search services via the network interface and receives search results as data structures including document identifiers, titles, snippets, and uniform resource locators. The server then accesses the referenced locations to obtain full document data, which may be represented in markup formats or semi-structured data formats.

The server applies a parsing algorithm to each document to extract text data. The server removes markup tags, scripts, and non-content sections and identifies main content blocks by analyzing structural patterns, such as tag depth, text density, and surrounding navigation structures. The server may apply heuristic rules or statistical models to distinguish main article text from ancillary content. The server normalizes character encoding, removes control characters, and performs language-specific tokenization and sentence segmentation. The server consolidates texts from multiple documents into a unified representation, such as a list of article objects, each containing title, body text, and metadata fields.

The server prepares input data for a generative AI model by constructing a prompt sentence. The server defines a specific prompt template that controls the behavior of the generative AI model. The server incorporates topic information, retrieval context, desired playback duration, and language information into the prompt template. By doing so, the server constrains the generative AI model to produce text that conforms to a predetermined narrative style, structure, and length, as opposed to unconstrained generation.

In one example, the server constructs the following prompt sentence:

“You are a generative AI model that creates concise podcast scripts. The user's topic is ‘technology'. Using the following web search results, generate a 5-minute script in English that summarizes the most important recent technology news. Start with a 2-sentence introduction, then describe 3-4 key news items with clear explanations, and end with a short conclusion. Write in a natural, spoken style suitable for audio narration. Avoid mentioning that you are an AI. Here are the collected texts: [COLLECTED_TEXT].”

In another example, the server constructs a more detailed prompt sentence for a different topic: “You are a generative AI model that prepares podcast scripts. The user's topic is ‘artificial intelligence in healthcare’. Using the following web search results, create a 7-minute script that explains the most important recent developments, their benefits, and potential risks. Write in clear English for a general audience, and structure the script into an introduction, three main sections, and a conclusion. Avoid using technical jargon without explanation. Here are the collected texts: [COLLECTED_TEXT].”

The server selects which prompt template to apply based on the user's playback time information and language information. The server may adjust numerical parameters in the prompt, such as the requested number of sections or approximate script length, to map the target duration to an approximate word count. For example, the server estimates that a speaking rate of 130-180 words per minute is appropriate, and computes a target script length by multiplying the target duration by a selected speaking rate value.

The server transmits the prompt sentence and at least part of the extracted text data to the generative AI model. The generative AI model is implemented as a neural network architecture such as a transformer, which includes multiple layers of self-attention mechanisms, feed-forward networks, and normalization components. The model is parameterized by high-dimensional weight matrices and bias vectors and has been trained in advance on large corpora of natural language text using supervised or self-supervised learning techniques.

During inference, the generative AI model receives the prompt sentence and input text tokens and applies a sequence of matrix multiplications, non-linear activation functions, and attention weight calculations to generate output token sequences. The model calculates attention scores between tokens in the prompt and tokens in the retrieved text, thereby focusing on segments that are most relevant to the requested topic and structure. The model iteratively predicts subsequent tokens based on probability distributions computed from its internal representations. The server receives the output tokens and decodes them into script text. The server may apply post-processing such as removal of control sequences, normalization of punctuation, and elimination of undesired self-references.

The server does not rely on generic, unconstrained generation; instead, the server enforces a non-conventional control strategy in which the prompt sentence explicitly encodes high-level structural rules, such as “introduction-body-conclusion” segmentation, item counts, and style constraints. This control strategy causes the generative AI model to allocate its internal attention and output distribution differently from conventional free-form generation. As a result, the script text exhibits reduced redundancy, improved thematic coherence, and more predictable length, which in turn simplifies downstream speech synthesis and audio mixing.

The server converts the generated script text into an audio signal by using a speech synthesis technique. The server may employ a neural text-to-speech engine that converts text into phoneme sequences and then into waveform samples using acoustic and vocoder networks. The speech synthesis engine is parameterized by speaker embeddings, prosody control parameters, and language-specific pronunciation rules. The server sends the script text, target language, and voice configuration to the speech synthesis engine, which returns digital audio data encoded in a compressed format. The server can control speaking rate and pitch to match the target duration and user preferences. The server stores the raw audio signal in a storage device as a file or as a stream of audio frames.

The server retrieves acoustic material data such as background music tracks and sound effects from a media library. The server maintains metadata for each acoustic material item, including genre, tempo, typical use (intro, background, transition), and duration. The server selects appropriate acoustic material data based on the user's background sound setting, topic information, and script structure. For example, the server may select calm background music for a healthcare topic and more dynamic music for a technology news topic. The server loads selected audio assets into memory in the form of audio segment data structures.

The server performs editing processing on the audio signal and the acoustic material data. The server represents each audio resource as a sequence of samples or as a higher-level segment structure with associated timing information. The server applies algorithms to adjust volume levels by computing gain coefficients and applying them to sample values. The server normalizes the voice track to a target loudness measurement, such as an integrated loudness value, to achieve consistent playback volume. The server adjusts time length by trimming or extending segments, and, when necessary, applies time-stretch algorithms that change duration while preserving pitch characteristics.

The server superimposes background music under the voice track by aligning time axes and summing scaled sample values of overlapping segments. The server performs section-by-section concatenation by concatenating audio segments in a predefined order, such as intro music, voice section, transition sound effect, next voice section, and outro music. By representing the audio program as a sequence of segments with explicit time offsets, the server can precisely control where background sound starts and ends, and where sound effects are inserted. This explicit segment representation allows non-uniform editing strategies that are difficult to achieve through manual or conventional batch processing.

The server generates edited audio data representing the final mixed content. The server encodes this edited audio data in a streaming-friendly format and stores it in a storage device or in a content delivery infrastructure. The server generates identification information and description information and associates them with the edited audio data. Identification information may include unique identifiers, while description information may include human-readable titles, summaries, topic labels, creation timestamps, and language codes. The server registers the edited audio data and associated metadata as distribution content in a repository managed by a distribution management apparatus or an external content delivery network.

The server prepares response data that includes location information of the distribution content. The server returns the response data to the terminal in reply to the original request. The terminal receives the response data and obtains the location information such as a uniform resource locator. The terminal then initiates streaming or download of the edited audio data from the content delivery infrastructure. The terminal decodes the streamed audio and outputs sound through its audio hardware. The user listens to the audio program that has been generated, edited, and distributed by the server according to the user's topic information and preferences.

The server improves computer technology in several ways. First, the server reduces processing latency and bandwidth consumption by integrating retrieval, generation, synthesis, and editing into a coordinated pipeline. The server uses structured data representations for intermediate results, enabling reuse and incremental updates of content instead of regenerating entire programs. Second, by mapping playback time information to target script length through explicit estimation and by controlling the generative AI model via a detailed prompt sentence, the server reduces variance in script length and thereby reduces the need for repeated synthesis and re-editing operations. This leads to improved computational efficiency and reduced resource usage on the server.

Third, the server reduces network load by separating content generation from delivery: the server generates a single edited audio asset per request and registers it with a content delivery infrastructure, which then performs progressive delivery to multiple terminals as needed. This architecture avoids repeatedly transmitting intermediate textual or audio data to terminals and offloads scalable streaming to specialized delivery nodes. Fourth, the server improves quality and consistency of audio output by applying algorithmic volume normalization, time alignment, and segment-based mixing, which are parameterized according to user preferences and content structure rather than being performed as static, one-size-fits-all processing.

The generative AI model used by the server is trained in a specific manner to support controllable script generation. During training, the model receives input pairs of instruction-like prompt sentences and reference texts labeled with structure markers, such as “<intro>”, “<section>”, and “<conclusion>”. The model minimizes a loss function such as cross-entropy between predicted tokens and reference tokens. The training process employs gradient-based optimization, adjusting weight parameters to approximate conditional probability distributions over text given prompts. The training data can be augmented by replacing topic tokens, shuffling or compressing sections, and injecting synthetic noise, which improves robustness of the model to noisy retrieval input. This training method results in a model that is better able to follow structured instructions than conventional models trained only on unstructured text, thereby improving the stability and predictability of script generation.

The server adopts non-conventional processing rules distinct from manual human editing. For example, the server calculates a relevance score for each sentence in the retrieved text by combining attention-based importance scores from the generative AI model with heuristic measures such as term frequency-inverse document frequency and sentence position. The server uses these scores to select or down-weight parts of the retrieved text that are fed into the prompt, thereby preventing excessively long or irrelevant input. This selective input mechanism reduces inference time and memory usage for the generative AI model and improves the topical focus of the generated script.

The server can be implemented in multiple alternative embodiments. In one embodiment, the generative AI model executes on the same physical machine as the server, using a graphics processing unit or a tensor processing accelerator to perform matrix operations. In another embodiment, the generative AI model executes on a remote inference service, and the server communicates with it via a low-latency network link. In yet another embodiment, the speech synthesis technique is implemented by a neural vocoder running on a dedicated digital signal processor. The audio editing library may also be replaced by any module capable of segment-wise editing and mixing based on explicit time indices.

The server may support different generative AI architectures, such as encoder-decoder models for multilingual translation of retrieved text into the user's preferred language before script generation, or models that jointly predict text and markup indicating insertion points for sound effects. The server may modify the prompt sentence format to include explicit markers indicating where sound effects should be placed, allowing tighter synchronization between narrative content and acoustic material data. For example, the prompt sentence may include instructions such as “Insert a transition sound effect after each main news item” so that the generated script includes markers, which the server later interprets to schedule sound effect insertion.

The system is not limited to news-related topics. The user can specify any topic, such as education, science, finance, or entertainment. The server can adapt the retrieval conditions, prompt sentence, and acoustic material selection to the topic domain. For educational topics, the server may instruct the generative AI model to include definitions and examples; for entertainment topics, the server may select more dynamic background music. In all cases, the server maintains the same core structure of retrieval, generative scripting, speech synthesis, and audio editing, and provides a repeatable and technically controlled pipeline that improves upon conventional, manual, or loosely coupled workflows.

By tightly integrating network-based retrieval, structured prompt control of a generative AI model, and programmable audio editing operations, the server achieves technical effects such as improved throughput for dynamic content generation, reduced variance in content length and quality, and reduced load on terminals and communication links. The described embodiments therefore provide concrete technical implementations that allow other skilled persons to realize and deploy the invention using general-purpose computing hardware and software modules adapted as described above.

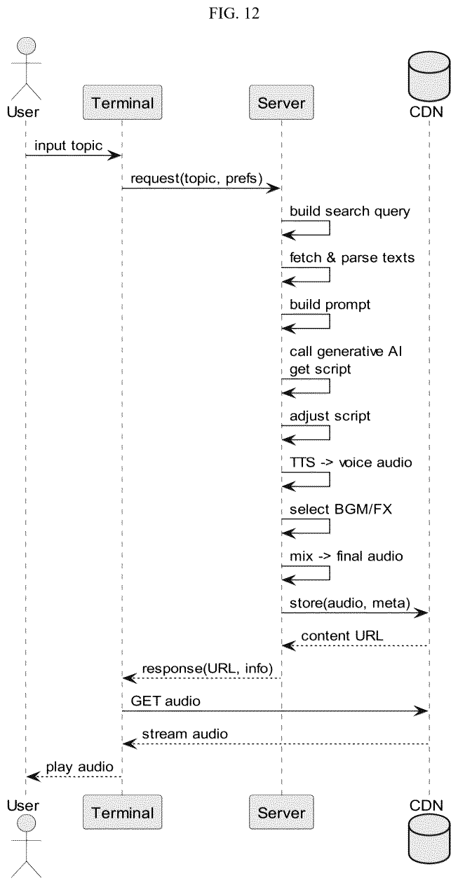

The following describes the processing flow using FIG. 12.

### Step 1

The user operates the terminal to input topic information and preferences.

The terminal displays an input screen that includes at least a text field for the topic, a language selector, a desired playback time selector, and a background sound on/off switch.

Input: user's topic string, selected language, desired playback time, background sound setting.

The terminal packages these values into a structured request and transmits the request to the server over a digital communication path using a request message.

Output: a request message containing topic information and preference parameters received by the server.

### Step 2

The server receives the request message from the terminal and validates the content.

Input: request message containing topic string, language code, playback time value, background sound flag, and user identifier.

The server parses the message, checks that mandatory fields are present and correctly formatted, and normalizes the topic string (for example, trimming whitespace and converting character encoding).

The server stores the parsed data in a request record in memory or a database, assigning a unique request identifier.

Output: a validated request record associated with a unique identifier and ready for further processing.

### Step 3

The server generates search conditions based on the topic information and preferences.

Input: validated request record including topic string, language code, and optional time range derived from the current timestamp and playback time.

The server constructs one or more query expressions by combining the topic string with additional search filters, such as language restriction and recency constraints, and formats them according to the protocol of an external search service.

The server encapsulates these expressions as search condition structures.

Output: one or more search condition structures suitable for use by an information retrieval engine.

### Step 4

The server executes an information retrieval process using the search conditions.

Input: search condition structures generated in Step 3.

The server sends network requests to one or more external search services, each request including query text, filter parameters, and authentication data.

The server receives search result data, which may include document identifiers, titles, summaries, and URLs, and aggregates the results into a unified search result list.

The server may rank or filter the search result list based on relevance scores returned by the search service or based on local heuristics such as keyword frequency and publication date.

Output: an aggregated search result list containing references to relevant document data.

### Step 5

The server retrieves document data and extracts text data.

Input: aggregated search result list containing URLs or identifiers of relevant documents.

The server issues network requests to the content sources identified by the URLs and downloads the corresponding document data, which may be in markup formats or semi-structured text formats.

The server applies parsing routines to remove non-content sections, detect main article regions, and extract textual information such as titles, body paragraphs, and captions.

The server performs normalization operations, including character set conversion, removal of control characters, sentence segmentation, and basic cleaning.

Output: a collection of cleaned text data objects, each associated with metadata (such as source, title, and language) and linked to the original search result list.

### Step 6

The server selects and aggregates text segments for input to the generative AI model.

Input: collection of cleaned text data objects and the original topic information.

The server computes relevance scores for individual sentences or paragraphs based on metrics such as keyword occurrence, position within the document, and optionally model-derived importance scores.

The server discards low-relevance or redundant segments and limits the total length to satisfy a token budget appropriate for the generative AI model.

The server concatenates or structures the remaining segments into an aggregated source text block, preserving references to their origins for traceability.

Output: an aggregated source text block that is focused, de-duplicated, and sized for efficient generative processing.

### Step 7

The server constructs a prompt sentence for the generative AI model.

Input: aggregated source text block, topic string, language code, and playback time value.

The server estimates a target script length (for example, number of words or tokens) by multiplying the playback time value by an assumed speaking rate, and decides a structural layout (such as introduction-main sections-conclusion).

The server generates a prompt sentence (or prompt text) that encodes instructions about topic, structure, style, and length, and includes an insertion position for the aggregated source text block.

The server embeds the aggregated source text block after the instructional portion of the prompt.

Output: a complete prompt text that includes explicit instructions and the aggregated source text, ready to be input to the generative AI model.

### Step 8

The server invokes the generative AI model to generate script text.

Input: complete prompt text created in Step 7.

The server transmits the prompt text to a generative AI model endpoint, specifying model parameters such as maximum output tokens, temperature, and decoding strategy.

The generative AI model performs internal neural network computations, including attention and feed-forward operations, to produce successive output tokens that collectively form a narrative script.

The server receives the token sequence from the model, decodes the tokens into a character string, and performs basic post-processing such as trimming leading and trailing whitespace and correcting obvious encoding issues.

Output: script text that is structured for audio narration and tailored to the topic and user preferences.

### Step 9

The server adjusts the script text according to playback constraints.

Input: raw script text from Step 8 and the playback time value.

The server calculates the approximate duration of the script based on word count and a default or user-specific speaking rate.

If the estimated duration exceeds the playback time value, the server summarizes or trims the text by removing low-priority sentences (for example, based on relevance scores or section importance).

If the estimated duration is significantly shorter, the server may expand certain sections by inserting clarification sentences or examples, optionally by re-invoking the generative AI model with a supplemental prompt.

Output: a length-adjusted script text whose estimated playback time is matched to the requested duration.

### Step 10

The server converts the script text into an audio signal using a speech synthesis technique.

Input: length-adjusted script text, language code, and optional voice configuration.

The server sends the script text and configuration parameters to a text-to-speech engine, which converts the text into phoneme or acoustic feature sequences and generates waveform samples through an acoustic model and a vocoder.

The server receives the synthesized audio stream, which is typically encoded in a compressed format such as an audio file or a sequence of frames.

The server stores the audio stream as a primary voice track in a storage device, associating it with the request identifier.

Output: a primary voice audio signal representing spoken narration of the script text.

### Step 11

The server selects acoustic material data for mixing.

Input: request record including background sound setting, topic information, and the structure of the script text (for example, number of sections).

The server accesses a media library that contains background music and sound effects with associated metadata such as genre, mood, and typical use.

The server selects one or more background music tracks and optional sound effects that match the topic or user preference (for example, calm background music for educational content or energetic music for technology news).

The server retrieves the selected acoustic material data into memory as audio segments, ready for mixing with the primary voice track.

Output: a set of selected acoustic material segments associated with the current primary voice track.

### Step 12

The server performs audio editing and mixing to generate edited audio data.

Input: primary voice audio signal from Step 10 and acoustic material segments from Step 11.

The server converts all audio segments to a common sampling rate and format if necessary and measures loudness levels for each segment.

The server normalizes the voice track to a target loudness and attenuates the background music tracks by a predetermined gain so that the narration remains clearly intelligible.

The server aligns the time axes of the segments, overlays background music under the voice track during selected intervals, and inserts sound effects at section boundaries determined from the structure of the script text.

The server concatenates an intro music segment, the mixed main section, and an outro music segment to form a single continuous program.

Output: edited audio data representing a mixed and fully arranged audio program corresponding to the user's request.

### Step 13

The server generates metadata and registers distribution content.

Input: edited audio data from Step 12 and the original request record.

The server creates identification information such as a unique content identifier and generates description information including title, summary, topic label, creation time, and language.

The server stores the edited audio data in a storage subsystem or content delivery infrastructure under a path or resource identifier derived from the content identifier.

The server associates the metadata with the storage location to form a distribution content entry in a content catalog or database.

Output: a registered distribution content entry that links edited audio data, identifiers, and descriptive metadata.

### Step 14

The server generates response data and returns it to the terminal.

Input: distribution content entry including content identifier, storage location, and description information.

The server constructs response data that contains at least location information (such as a playback URL) and optionally the title, duration, and topic label of the edited audio program.

The server transmits the response data to the terminal as a reply to the initial content generation request.

Output: a response message at the terminal that specifies where and how the edited audio data can be accessed.

### Step 15

The terminal obtains and plays back the edited audio data for the user.

Input: response message containing location information and metadata for the edited audio program.

The terminal initiates a streaming or download session to the specified location in the content delivery infrastructure and receives audio data in a streaming fashion or as a complete file.

The terminal decodes the audio data using a media playback component and outputs sound through its audio hardware to the user.

The user listens to the dynamically generated audio program that has been tailored to the user's topic and preferences.

Output: audio playback delivered to the user, completing the processing cycle for the requested topic.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional information delivery systems and content recommendation engines typically rely on simple keyword matching, static rules, or coarse-grained user segmentation to select information items and to generate content. Such systems frequently retrieve generic content that is not well aligned with fine-grained user preferences, such as preferred topic focus, preferred content length, or preferred medium type. As a result, the user often receives news or other information that is either too long, too short, off-topic, or presented in an unsuitable modality, which degrades user engagement and satisfaction.

Moreover, existing systems that employ generative AI models usually pass only the user's current query or a limited set of source documents to the model. These systems do not construct prompt sentences that deeply encode a structured user profile and ranked context from multiple information items. Consequently, the generative AI model operates in a partially informed manner and may generate content that is not optimally personalized, that ignores important aspects of the user's historical behavior, or that redundantly covers information that the user has already consumed.

From a computer-technology perspective, there is also a limitation in how computational resources are used to personalize content. Many systems either (i) perform expensive, model-level fine-tuning for each user, or (ii) repeatedly generate similar content without effectively reusing or structuring historical usage information. Such approaches can cause inefficient use of processing resources, increased network traffic due to multiple retrieval and generation attempts, and latency that is disproportionate to the quality of personalization achieved. There is a need for a technical mechanism that systematically transforms raw usage history data into a structured user profile and uses that profile to control both information retrieval and prompt construction, thereby improving the effectiveness of generative AI processing without requiring substantial changes to the underlying model architecture.

Accordingly, a technical problem exists in providing a computer-implemented system that (i) analyzes detailed usage history information to derive a user profile capturing topic preferences, content-length preferences, and medium preferences, (ii) retrieves and ranks multiple information items based on both query terms and the user profile, and (iii) constructs a context-rich prompt sentence for a generative AI model so that the model generates user-specific news or other content efficiently and with improved relevance. There is a further problem of integrating this generated content with speech synthesis and audio editing, to produce edited audio data that is adapted to the user, while maintaining low latency and efficient utilization of computing and network resources.

The specific processing by the specific processing unit 290 of the data processing device 12 in Example 2 is realized by the following means.

The present invention provides a server comprising a processor configured to receive, from a terminal operated by a user, classification information and search terms via an input unit; to acquire, from a storage device, usage history information corresponding to user identification information included in the received classification information and search terms; to analyze the usage history information by statistical processing or machine learning processing to generate a user profile indicating at least a preference for topic categories, a preference for content length, and a preference for medium type; to acquire, from an external information source, a plurality of information items corresponding to the classification information and the search terms; to rank the plurality of information items according to a relevance to the user profile; to construct a prompt sentence for a generative AI model, the prompt sentence including content generation conditions that vary for each user and context information including summaries of higher-ranked information items and descriptive information of the user profile; to input the constructed prompt sentence into the generative AI model to cause the generative AI model to perform natural language processing and generate text data or script data for audio content in which the information items are summarized and restructured based on the user profile; to convert the generated text data into audio data by a speech synthesis technique; to add at least one of sound effect information and music information to the audio data to generate edited audio data; and to deliver at least one of the generated text data and the edited audio data to the terminal via a digital communication path. This enables the computing system to transform raw usage history into a structured control signal for both information retrieval and prompt construction, thereby improving the technical performance of the content generation pipeline by producing user-personalized news or other content with higher relevance and reduced redundant processing, while efficiently utilizing processing and network resources and providing low-latency, tailored audio and text outputs.

The term “processor” refers to a hardware computation unit or a set of hardware computation units, such as a central processing unit or a graphics processing unit, that executes machine-readable instructions to perform the functions described in the present disclosure.

The term “terminal” refers to an electronic device operated by a user, including but not limited to a mobile communication device, a tablet device, a portable computer, or a stationary computer, that is configured to transmit information to and receive information from the server.

The term “classification information” refers to data indicating at least one category, genre, or topic class specified by a user or predetermined by a system, which is used as a condition for information retrieval and content generation.

The term “search terms” refers to one or more character strings, words, or phrases input by a user or generated by a system, which are used as keywords for retrieving related information from an external information source.

The term “input unit” refers to a functional element implemented in hardware, software, or a combination thereof, that receives data such as classification information, search terms, and user identification information from the terminal or from another system component.

The term “user identification information” refers to data that uniquely or pseudo-uniquely identifies a user or a user account, such as an identifier, a token, or a pseudonymous code, and that is used to associate the user with usage history information.

The term “usage history information” refers to data representing past interactions of the user with content or services, including but not limited to viewed items, listened items, accessed topics, timestamps, content lengths, and media types, which is stored in a storage device.

The term “storage device” refers to a physical or virtual data storage resource, such as a semiconductor memory, a magnetic storage medium, or a network-accessible storage medium, that is configured to store usage history information, user profiles, content data, and related metadata.

The term “statistical processing” refers to a computational procedure that analyzes data using statistical techniques, such as aggregation, frequency counting, weighting, or normalization, to derive parameters or features representing characteristics of the data.

The term “machine learning processing” refers to a computational procedure in which a model is trained or applied to data using an algorithm such as classification, clustering, regression, or topic modeling, to infer patterns, preferences, or predictive relationships from the data.

The term “user profile” refers to structured attribute information generated from usage history information, indicating at least one of a user's preference for topic categories, preference for content length, and preference for medium type, and optionally including additional attributes such as preferred style or preferred complexity.

The term “topic category” refers to a classification label or concept that groups content items according to subject matter, such as technology, economics, health, or other thematic domains.

The term “content length” refers to a quantitative measure of the size or duration of content, such as a number of words, a number of characters, or a playback time of audio content.

The term “medium type” refers to a modality of content presentation, including but not limited to text content, audio content, video content, or a combination thereof.

The term “external information source” refers to a system, service, or data repository that provides information items, such as a database, a search engine, or a content distribution platform, accessible via a communication network.

The term “information item” refers to a unit of content obtained from an external information source, such as a document, an article, a record, or another data object, including at least textual information and optionally metadata such as title, timestamp, and tags.

The term “related information” refers to one or more information items that correspond to classification information and search terms and that are retrieved from an external information source as candidates for use in content generation.

The term “ranking” refers to an ordering operation that assigns an order or score to a set of information items according to a relevance measure, such as similarity to a user profile, keyword matching, or recency, and arranges the items in descending or ascending order.

The term “relevance” refers to a quantitative or qualitative measure indicating how closely a given information item matches the user profile, classification information, and search terms.

The term “generative AI model” refers to a machine-learned model configured to generate new data, such as natural language text, based on input data, and typically implemented as a parametric model trained on large-scale data sets, such as a neural network-based language model.

The term “prompt sentence” refers to a sequence of natural language expressions and optionally structured tokens, provided as an input instruction to a generative AI model, that specifies content generation conditions, context information, and constraints.

The term “content generation conditions” refers to parameters or instructions included in the prompt sentence that define properties of output content, such as target content amount, writing style, focus topic, tone, or level of detail.

The term “context information” refers to data supplied to the generative AI model together with content generation conditions, including summaries, excerpts, or metadata from information items and descriptive information derived from the user profile, which guide the model's generation.

The term “text data” refers to content represented in a character-based or symbol-based format, including but not limited to sentences, paragraphs, or full documents, generated by the generative AI model.

The term “script data for audio content” refers to text data structured as a script intended for audio presentation, including narrative text, dialogue, or announcements, which is suitable for conversion into speech.

The term “natural language processing” refers to computational processing of human language by a machine, including tasks such as understanding prompts, generating text, summarizing information, and restructuring content.

The term “speech synthesis technique” refers to a computational method for converting text data into audio data that represents speech, including parametric synthesis, concatenative synthesis, or neural network-based synthesis.

The term “audio data” refers to digital data representing sound, including synthesized speech and optionally additional elements such as music or sound effects, encoded in a suitable audio format.

The term “sound effect information” refers to data describing non-speech audio elements, such as beeps, transitions, ambient sounds, or other effects, that are added to speech audio data to enhance presentation.

The term “music information” refers to data representing musical audio elements, such as background music tracks or jingles, that can be combined with speech audio data.

The term “edited audio data” refers to audio data that has been generated by speech synthesis from text data and then modified by adding, mixing, or adjusting at least one of sound effect information and music information.

The term “digital communication path” refers to a logical or physical communication channel implemented over a communication network, such as a wired network, a wireless network, or a combination thereof, used to transmit data between the server and the terminal.

The following exemplary embodiments describe ways of carrying out the invention in practice. In each sentence, the subject is the server, the terminal, or the user.

The server includes one or more processors, a main memory, a non-volatile storage device, and a network interface. The server is implemented, for example, on a general-purpose computer platform or a virtual machine instance provided by a cloud computing environment. The server executes an operating system such as a general-purpose server operating system and runs application software including a web server, an application framework, a database management system, and a generative AI inference framework.

The terminal includes at least one processor, a memory, a display, an audio output unit, and a communication module. The terminal is implemented, for example, as a smartphone, a tablet device, or a personal computer. The terminal executes a client application implemented using a user interface framework such as a cross-platform mobile framework or a native operating system user interface toolkit. The terminal includes an input unit, such as a touchscreen or keyboard, for receiving classification information and search terms from the user.

The user operates the terminal to start the client application and to provide classification information and search terms through the input unit. The terminal converts the user's input operations into digital data, stores the data in a local memory, and transmits the data to the server over a packet-based communication network such as the Internet using a secure transport protocol.

The server executes an application program configured in accordance with the claims. The server stores usage history information, user profiles, content metadata, and generative AI model parameters in a storage device such as a relational database, a key-value store, and a file-based object store. The server uses a database management system to manage usage history information in structured data tables. The server stores each usage history record as a structured tuple including, for example, a user identifier, a content identifier, a topic category code, a timestamp, a consumed length, a medium type flag, and a device type flag.

The server generates a user profile by executing an analysis module implemented in a programming language such as a scripting language running on the server platform. The server loads usage history information for a particular user into an in-memory data structure such as a table or a matrix. The server executes statistical processing such as counting and averaging to derive topic occurrence frequencies, mean and variance of content length, and distribution of medium types. The server normalizes these values to generate a topic preference vector, a content length preference parameter, and a medium type preference parameter.

The server, in one embodiment, represents the topic preference vector as a fixed-length numerical vector where each element corresponds to a predefined topic category and stores a weight in a real number range. The server calculates each weight using a weighting scheme such as term frequency-inverse document frequency or a normalized count. The server stores the resulting user profile in the storage device as a record containing a user identifier and serialized profile parameters. The server reuses this user profile in subsequent content generation operations, thereby avoiding redundant recomputation and improving computational efficiency.

The server uses an information retrieval module to access an external information source. The server communicates with an external content index implemented by a search engine or by a database that stores text-based information items such as news articles or information records. The server sends search queries including classification information and search terms to the external information source through a network interface using an application programming interface. The server receives a list of candidate information items as structured data including title fields, body fields, topic tags, timestamps, and relevance scores computed by the external information source.

The server performs additional ranking of the candidate information items by combining the external relevance scores with similarity to the user profile. The server computes, for example, a cosine similarity value between a topic tag vector of each information item and the topic preference vector of the user profile. The server then computes a composite relevance score based on a weighted sum of the external relevance score, the cosine similarity, and a recency factor derived from the timestamp of the information item. The server sorts the information items in descending order of the composite relevance score and selects a predetermined number of top-ranked information items for further processing.

The server generates context information to be supplied to a generative AI model. The server extracts representative sentences from each selected information item, for example the title and leading sentences, and optionally applies a sentence scoring algorithm such as frequency-based scoring or a graph-based ranking algorithm to identify the most informative sentences. The server truncates overly long content while preserving key facts, thereby controlling the size of context information and reducing token consumption in subsequent generative AI processing.

The server constructs a prompt sentence for the generative AI model by concatenating generation instructions, user profile descriptions, and the extracted context information into a single natural language text sequence. The server, for example, generates a prompt sentence of the following form: “You are a news-writing assistant. Please use the following source articles to generate an original, up-to-date news article about technology with a strong focus on AI.

The user is especially interested in enterprise AI tools, real-world applications, and short, easy-to-understand explanations.

Please write about 600 words, avoid copying any sentences verbatim from the sources, and organize the article with a clear title and several short paragraphs.

Source article 1:[excerpt from article 1]

Source article 2:[excerpt from article 2]

Source article 3:[excerpt from article 3].”

The server derives the phrase “about 600 words” from the content length preference parameter in the user profile and derives phrases such as “short, easy-to-understand explanations” from the user's historic behavior indicating longer dwell time on concise content. The server uses such explicit encoding of user profile attributes into the prompt sentence to control the generative AI model's behavior without modifying model weights, thereby improving personalization in a resource-efficient manner.

The server executes a generative AI model implemented as a large-scale neural network, such as a transformer-based language model. The server stores model parameters including weight matrices, bias vectors, and layer normalization parameters in a model storage area of the storage device. The server loads the model parameters into a high-speed memory of a processing unit such as a graphics processing unit or a specialized accelerator. The server uses an inference framework to execute the generative AI model.

The server, in a typical implementation, uses a transformer architecture comprising an embedding layer, multiple self-attention layers, and feed-forward layers. The server converts the prompt sentence into a token sequence by applying a tokenizer that maps character strings to discrete token identifiers. The server passes the token sequence through the embedding layer to obtain dense vector representations. The server applies multi-head self-attention operations, where each attention head computes attention weights by scaled dot-product operations over query, key, and value vectors. The server then applies position-wise feed-forward networks with non-linear activation functions to obtain intermediate and final hidden states. The server, at each decoding step, computes a probability distribution over possible next tokens and selects a token according to a sampling strategy such as nucleus sampling or greedy decoding, thereby generating a sequence of output tokens.

The server converts the output token sequence into a text string representing generated text data or script data for audio content. The server structures this text into sections including a title and multiple paragraphs by inserting line breaks or markup based on punctuation and sentence boundaries. The server stores the generated text data in the storage device together with metadata such as a timestamp and the user identifier. The server thereby forms a persistent record of generated content that can be reused or audited later.

The server uses a speech synthesis engine to convert the generated text data into audio data. The server connects to a text-to-speech service implemented as a neural network-based speech synthesizer or a parametric synthesizer. The server sends the text data as an input sequence and specifies parameters such as language code, voice type, speaking rate, and output audio format. The server receives synthesized audio waveforms encoded in a file format such as a compressed audio format. The server then uses an audio processing module to add sound effects and music. The server mixes background music and sound effects with the synthesized speech according to a predetermined mixing rule or a rule selected based on the user profile, thereby generating edited audio data.

The server delivers the generated text data and the edited audio data to the terminal through a communication module. The server packages references to content, such as uniform resource locators for the text and audio files, into a response message and transmits the message over a network connection. The server may use a content delivery infrastructure to reduce latency and bandwidth consumption by caching frequently requested content near the terminal. The server logs transmission statistics including data sizes, transfer times, and error rates in order to monitor and optimize system performance.

The terminal receives the response message and parses the received data. The terminal stores the text data and audio data locally in a memory or file system for subsequent display and playback. The terminal presents the title and body text on the display in a structured layout and provides user interface controls such as play, pause, and seek for the audio content. The terminal invokes an audio playback module of the operating system to decode and play the edited audio data through a speaker or a connected audio output device.

The user reads the generated text content and listens to the edited audio content. The user may perform further interactions, such as rating the content or selecting additional topics, which the terminal sends back to the server as additional usage history information. The server updates the user profile using newly collected usage history, thereby refining topic preferences and content-length preferences over time. The server thus implements a feedback loop that continuously adapts the generative AI processing to the user's evolving preferences.

The server, from a technical perspective, improves the operation of the computing system beyond simple automation of human tasks. The server converts raw usage history into structured numerical vectors and parameters that directly control both information retrieval and prompt construction. The server thereby reduces unnecessary generation cycles by steering the generative AI model toward highly relevant portions of the information space on the first attempt. The server reduces communication load by limiting the amount of context data supplied to the model through summarization and ranking, leading to fewer tokens per request and fewer retries. The server improves processing speed by avoiding exhaustive search over all available information items and by reusing stored user profiles.

The server improves accuracy of generated content because the ranking based on similarity between information items and user profiles increases the probability that the most relevant information items are used as context. The server's construction of structured, profile-aware prompt sentences yields outputs that better match desired length, style, and topic focus, thereby reducing the need for post-processing and regeneration. The server's specific architecture, including explicit computation of composite scores, token-level control of prompt size, and dynamic inclusion of user profile descriptors, forms a non-conventional data processing pattern that is tailored to the technical characteristics and constraints of transformer-based generative AI models.

The server, in some embodiments, trains the generative AI model on a training data set using supervised or semi-supervised learning. The server computes an error function such as cross-entropy loss between predicted tokens and ground-truth tokens and updates the model weights by gradient-based optimization such as stochastic gradient descent or a variant thereof. The server may apply data augmentation techniques such as paraphrasing or back-translation during training to increase robustness. The server may also fine-tune a pre-trained model on domain-specific corpora such as technology news articles, thereby improving generation quality in targeted domains.

The server uses user profiles during inference rather than during training in order to avoid per-user fine-tuning overhead. The server, instead of updating model weights per user, modifies the prompt sentence structure, content, and constraints, which is a technique often referred to as prompt conditioning or in-context control. The server thereby achieves personalization and high-quality generation while maintaining a single shared model instance, which is more efficient in terms of memory usage and computational cost than maintaining separate models per user.

The server, in alternative embodiments, employs different ranking algorithms, feature representations, or neural network architectures. The server may use a dual-encoder model to compute semantic similarity between information items and user profiles, where one encoder maps user profile vectors and another encoder maps document embeddings into a shared vector space. The server may use a recurrent neural network, a convolutional neural network, or a hybrid architecture instead of or in addition to the transformer architecture. The server may encode user profiles not only as scalar preferences but also as learned embedding vectors trained jointly with a recommendation module.

The server, in other embodiments, applies the same principles to modalities beyond text and audio. The server may retrieve video content and generate script data for video narration using a generative AI model and integrate subtitles and narration into multimedia content while still leveraging the same profile-driven prompt construction. The server may also adjust bit rates or resolution according to user profiles and network conditions to further improve technical efficiency of media distribution.

The terminal, in alternative embodiments, executes offline caching of generated content and usage history. The terminal can store frequency-reduced representations of usage history and send them to the server in batches, reducing signaling overhead. The terminal can also use a local lightweight model to perform pre-filtering of user input or local summarization of displayed content. The server can then rely on such local processing to further reduce the amount of remote computation per user request.

The user can use the system in various contexts, such as consuming personalized news, educational content, or information briefings. The same underlying technical mechanisms, including user profile generation, context-aware information ranking, and prompt construction for a generative AI model, are applied in each context. The system thus provides a general framework that improves computational efficiency, communication efficiency, and personalization accuracy in a broad range of information delivery applications, while focusing on specific, technically defined data structures, algorithms, and neural network operations inside the server and the terminal.

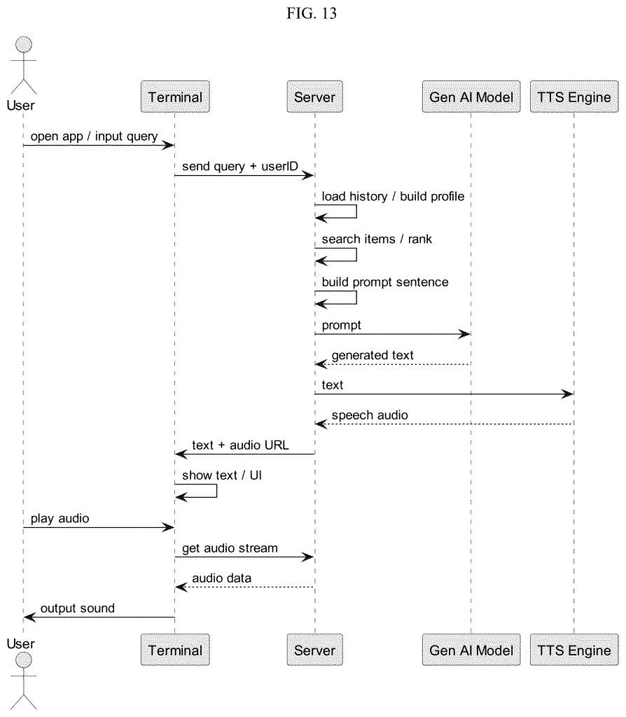

The following describes the processing flow using FIG. 13.

### Step 1

The user operates the terminal to launch an application and to input classification information and search terms. The terminal receives, as input, touch or keyboard events representing category selections and keyword strings. The terminal converts these events into structured data including a classification field and a list of search term strings, and the terminal displays the entered values on the screen as output for confirmation.

### Step 2

The terminal acquires user identification information and local usage history data from a local storage area. The terminal receives, as input, a request from the application logic to load a stored user identifier and recent interaction logs. The terminal performs data access operations on a local database or preference store to retrieve records such as previously read content IDs and timestamps, and the terminal outputs a combined data object containing the user identifier, the classification information, the search terms, and the local usage history.

### Step 3

The terminal constructs and transmits a request message to the server. The terminal receives, as input, the combined data object containing the user identifier, classification information, search terms, and local usage history. The terminal serializes these fields into a message format such as a JSON structure and performs data encoding and header attachment to form an HTTP or similar protocol request, and the terminal outputs a network packet stream addressed to the server over a digital communication path.

### Step 4

The server receives and parses the request message from the terminal. The server receives, as input, the network packet stream containing the serialized request. The server performs protocol processing to reconstruct the request body, then decodes the JSON structure into internal data structures representing the user identifier, classification information, search terms, and local usage history, and the server outputs validated request parameters to an application-layer processing module.

### Step 5

The server retrieves extended usage history information from a storage device. The server receives, as input, the user identifier contained in the parsed request parameters. The server executes a query against a usage history database, performs index-based search on a user ID field, and loads matching records such as topic category codes, content lengths, medium types, and timestamps. The server then combines the retrieved records with the local usage history data, and the server outputs a unified usage history dataset for that user.

### Step 6

The server analyzes the unified usage history dataset to generate a user profile. The server receives, as input, the unified usage history records. The server performs statistical processing, such as counting occurrences of each topic category, calculating mean and variance of consumed content lengths, and computing ratios of medium types. The server then normalizes the topic counts to form a topic preference vector and converts length statistics into a preferred length range, and the server outputs a structured user profile containing numerical preference parameters.

### Step 7

The server retrieves candidate information items from an external information source. The server receives, as input, the classification information and search terms from the request parameters. The server constructs a search query string or structured query by combining the classification and search terms, applies tokenization and normalization to reduce variation in the terms, and sends the query to an external index or content repository. The server then receives, as output, a set of candidate information items, each represented as a record containing at least a title, a body text, topic tags, and a timestamp.

### Step 8

The server ranks the candidate information items according to relevance to the user profile. The server receives, as input, the candidate item records and the user profile. The server converts topic tags of each item into a topic vector in the same space as the topic preference vector and computes a similarity measure such as cosine similarity between each item vector and the user profile vector. The server then combines this similarity value with other factors such as base relevance scores and recency factors, using a weighted sum to produce a composite score for each item, and the server outputs an ordered list of information items sorted in descending order of composite score.

### Step 9

The server selects top-ranked information items and generates context summaries. The server receives, as input, the ordered list of information items. The server truncates the list to a predetermined number of top items and performs text processing on each selected item, including sentence segmentation and extraction of representative sentences such as titles and leading sentences. The server may compute a local sentence score based on keyword frequency to choose the most informative sentences, and the server outputs condensed text snippets for each selected information item as context summaries.

### Step 10

The server constructs a profile-aware prompt sentence for a generative AI model. The server receives, as input, the user profile, the context summaries, and the request parameters including classification information and search terms. The server formats generation constraints such as target word count, desired style, and focus topics based on the profile parameters, and the server concatenates these constraints with natural language instructions and the context summaries into a single coherent prompt sentence. The server thereby performs string concatenation, template filling, and insertion of descriptive profile text, and the server outputs a completed prompt sentence that specifies content generation conditions and includes contextual information.

### Step 11

The server executes the generative AI model using the prompt sentence as input. The server receives, as input, the constructed prompt sentence. The server tokenizes the prompt sentence into a sequence of token identifiers and feeds the token sequence into a trained neural network model, such as a transformer-based language model, executing matrix multiplications, attention weight computations, and non-linear activations across multiple layers. The server decodes the model's output token sequence into natural language text, and the server outputs generated text data or script data for audio content that summarizes and restructures the related information according to the prompt conditions.

### Step 12

The server post-processes the generated text data and associates metadata. The server receives, as input, the raw generated text data. The server performs length checking by counting characters or words, performs basic content validation such as checking for empty output or forbidden terms, and splits the text into sections such as title and body paragraphs using punctuation and line-break heuristics. The server then generates metadata including a content identifier, a creation timestamp, and the associated user identifier, and the server outputs a structured content object comprising the processed text and the metadata.

### Step 13

The server converts the generated text data into synthesized audio data. The server receives, as input, the processed text data and metadata including language information and user preferences for medium type. The server sends the text string and configuration parameters to a text-to-speech engine, which internally converts text into phonetic sequences, applies acoustic modeling, and generates waveform samples. The server receives an audio file as output, in a digital format such as a compressed audio format, and the server outputs synthesized speech audio data corresponding to the text.

### Step 14

The server edits the synthesized audio data by adding sound effects and music. The server receives, as input, the synthesized speech audio data and one or more pre-stored sound effect tracks and music tracks. The server aligns the tracks on a time axis, applies mixing operations such as gain adjustment, fading, and panning, and combines the tracks into a single audio stream. The server then encodes the mixed audio into an output format suitable for streaming or download, and the server outputs edited audio data that contains speech with added sound effects and music.

### Step 15

The server stores and prepares the generated content for delivery. The server receives, as input, the structured content object and the edited audio data. The server writes the text content and audio file to persistent storage such as an object store or database, assigns a unique resource path or locator to each file, and creates index entries linking the user identifier to the new content. The server then constructs a delivery descriptor including the content identifier, text summary, and audio resource locator, and the server outputs this descriptor to a response construction module.

### Step 16

The server transmits the delivery descriptor and associated content to the terminal. The server receives, as input, the delivery descriptor and any additional response metadata. The server serializes this information into a response message, including fields for title, body text, and audio URL, and sends the response over the communication network using a transport protocol. The server may also initiate or support streaming of the audio data from a content server, and the server outputs network packets directed to the terminal.

### Step 17

The terminal receives and processes the response from the server. The terminal receives, as input, the network packets containing the response message. The terminal reconstructs the message, parses the serialized data into internal data structures, and extracts text content, content identifiers, and audio URLs. The terminal then stores the text and resource locators in local storage for later access, and the terminal outputs structured content ready for presentation in the user interface.

### Step 18

The terminal displays the generated text content and prepares audio playback controls. The terminal receives, as input, the structured content including title, body text, and the audio URL. The terminal renders the title and body text on the display using layout routines and font rendering, and the terminal creates user interface elements such as play buttons and progress bars associated with the audio URL. The terminal outputs a graphical screen where the user can read the generated content and can choose to start audio playback.

### Step 19

The terminal retrieves and plays back the edited audio data upon user request. The user operates the terminal to tap a play button or similar control. The terminal receives, as input, this user action and the audio URL associated with the content. The terminal opens a media session, requests the audio stream from the server or a content server using the URL, and receives streaming audio packets. The terminal decodes the audio stream and sends digital audio samples to a digital-to-analog converter and speaker or connected audio device, and the terminal outputs audible playback of the edited audio content to the user.

### Step 20

The terminal logs new interaction events and sends updated usage history to the server. The terminal receives, as input, interaction events such as reading duration, scrolling behavior, audio playback duration, and user feedback. The terminal aggregates these events into compact records, including timestamps and content identifiers, and stores them locally. The terminal periodically or upon session completion transmits the aggregated usage history records to the server as an update message, and the terminal outputs refined usage history data that serves as new input to subsequent analysis and user profile updating at the server.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

In conventional information delivery systems that convert textual information into audio content, a processor typically retrieves documents based on simple keyword searches and converts the full text into speech using a basic text-to-speech engine. Such systems suffer from several technical limitations. First, they treat user requests as unstructured text and do not systematically decompose the requests into machine-interpretable topic information, keyword information, emotion state information, and history information. As a result, the processor cannot effectively control downstream processing modules, such as information retrieval, summarization, and scheduling, based on a unified representation of user context.

Second, conventional systems do not tightly integrate generative AI models through explicit and structured prompt sentences. In many cases, generative models, if used at all, are invoked with ad-hoc or static prompts that are not adapted to user-specific emotion states, usage history, or current retrieval results. This leads to unstable output quality, inefficient use of computing resources, and an inability to deterministically control output length, tone, or structure, which degrades the overall performance and predictability of the system.

Third, traditional text-to-speech pipelines operate as isolated components. The audio conversion and editing stages are typically unaware of user behavior logs, emotion analysis, or ranking decisions applied to the source information. As a consequence, the system cannot optimize the content structure, background sound, or delivery timing in a way that aligns with user preferences or usage patterns. This results in unnecessary network transmissions, under-utilization of generated content, and increased computational overhead due to repeated generation of content that is never meaningfully consumed.

Fourth, known systems lack a feedback-driven learning loop tightly integrated into the processing pipeline. Although user interaction data such as playback completion rates or skip events may be logged, these logs are rarely used to automatically update internal processing conditions for parsing, selection, prompt generation, and delivery scheduling. Therefore, the processor is not able to incrementally improve ranking accuracy, prompt design, or timing optimization, which limits the system's ability to adapt to long-term and fine-grained changes in user behavior.

Accordingly, there is a need for a technical solution that reconfigures the processor, memory, and network interfaces of an information delivery system so that: (i) user requests and context are normalized into structured control data including topic information, keyword information, emotion state information, and history information; (ii) generative AI models are driven by dynamically constructed prompt sentences that encode this control data; (iii) audio generation and editing are orchestrated under these same control parameters; and (iv) user feedback is fed back into the processing pipeline to automatically adjust analysis, selection, and scheduling logic. Such a solution should improve computational efficiency, determinism and controllability of generative processing, resource utilization on digital networks, and overall system responsiveness, thereby providing a concrete improvement in computer-implemented information processing technology.

The specific processing by the specific processing unit 290 of the data processing device 12 in Application Example 2 is realized by the following means.

The present invention provides a server comprising a processor and a memory storing instructions that, when executed by the processor, cause the processor to acquire information in response to a user request by using an information retrieval unit; analyze text data based on the user request to extract topic information, keyword information, emotion state information, and history information by using an analysis unit; evaluate correlation, novelty, and emotion suitability of the acquired information based on the topic information, the keyword information, the emotion state information, and the history information, and select and rank the acquired information by using a selection unit; generate, by using a generation unit, a prompt sentence that instructs a generative AI model to perform summarization or content generation, by using the information selected by the selection unit as input information and by setting tone, style, and length parameters in accordance with the emotion state information and the history information; input the prompt sentence into the generative AI model and obtain text data output from the generative AI model by using a text generation unit; convert the text data obtained by the text generation unit into audio data by using an audio conversion unit; add background sound, music, or sound effects to the audio data generated by the audio conversion unit and edit a playback structure of the audio data by using an editing unit; transmit the edited audio data to a user terminal via a digital network and optimize delivery timing based on the emotion state information and the history information by using a delivery unit; and update processing conditions of the analysis unit, the selection unit, and the generation unit based on playback history information and operation history information acquired from the user terminal by using a learning unit. This enables the server to implement a unified, feedback-driven processing pipeline in which structured control data derived from user context governs information retrieval, generative AI prompt construction, audio synthesis, and delivery scheduling, thereby improving the technical performance of the computer system in terms of generation quality, controllability of generative output, computational efficiency, resource utilization on the digital network, and adaptability to user behavior.

The term “information retrieval unit” refers to a functional module implemented by hardware and/or software that receives a user request and, based on parameters derived from the request, obtains corresponding information from one or more data sources, including external networks or internal data stores.

The term “analysis unit” refers to a functional module implemented by hardware and/or software that processes input data, such as text data, audio data, image data, or behavioral log data, and extracts structured control information including topic information, keyword information, emotion state information, and history information.

The term “topic information” refers to structured data representing one or more subject categories or themes inferred from a user request or from retrieved information, such as a high-level classification indicating a field, domain, or content category.

The term “keyword information” refers to structured data representing one or more terms, phrases, or identifiers extracted from a user request or from retrieved information, which are used as search conditions, filtering conditions, or control parameters for downstream processing.

The term “emotion state information” refers to structured data representing an estimated emotional condition of a user, such as joy, sadness, neutrality, or other emotional category, optionally including an intensity or confidence value, derived from analysis of audio data, image data, text data, or usage context.

The term “history information” refers to structured data representing past user activity, including but not limited to playback records, operation records, consumed content categories, and time-of-use patterns, used to influence subsequent analysis, selection, and scheduling operations.

The term “selection unit” refers to a functional module implemented by hardware and/or software that evaluates acquired information based on correlation, novelty, emotion suitability, and one or more items of control information, and that selects and ranks the acquired information according to predetermined or learned criteria.

The term “correlation” refers to a quantitative or qualitative measure indicating how closely a piece of information matches one or more elements of control information, such as topic information, keyword information, emotion state information, or history information.

The term “novelty” refers to a measure indicating how recently or infrequently a piece of information has been presented to the user or appears in the system, relative to past history information or temporal thresholds.

The term “emotion suitability” refers to a measure indicating the degree to which a piece of information is appropriate for a current or target emotion state, based on predefined rules, learned relationships, or content analysis.

The term “generation unit” refers to a functional module implemented by hardware and/or software that constructs a prompt sentence for a generative AI model by combining selected information with control parameters, including tone, style, length, and structure settings.

The term “prompt sentence” refers to a machine-readable text instruction that specifies to a generative AI model how to process input information, including at least one of a requested operation type, a desired tone, a target length, a target structure, or constraints on the generated output.

The term “generative AI model” refers to a machine-implemented model, such as a neural network, that receives a prompt sentence and optionally additional input data, and generates new text data by performing probabilistic or deterministic sequence generation.

The term “text generation unit” refers to a functional module implemented by hardware and/or software that transmits a prompt sentence and associated data to a generative AI model, receives generated text data from the generative AI model, and outputs the generated text data for further processing.

The term “audio conversion unit” refers to a functional module implemented by hardware and/or software that converts text data into audio data by applying speech synthesis processing, including phonetic analysis, prosody generation, and waveform synthesis.

The term “editing unit” refers to a functional module implemented by hardware and/or software that processes audio data by adding background sound, music, or sound effects, and by modifying one or more properties of the audio data, such as segment order, timing, volume level, or fades, to form a playback structure.

The term “playback structure” refers to an arrangement of one or more audio segments, including generated speech segments and optional background or effect segments, organized with specific timing, ordering, and audio mixing parameters for presentation to a user.

The term “delivery unit” refers to a functional module implemented by hardware and/or software that transmits audio data or related metadata from a server to a user terminal via a digital network, and that determines or adjusts a delivery time or method based on control information including emotion state information and history information.

The term “learning unit” refers to a functional module implemented by hardware and/or software that receives playback history information and operation history information, performs aggregation or model training, and updates processing conditions or parameters of at least one of the analysis unit, the selection unit, the generation unit, or the delivery unit.

The term “playback history information” refers to structured data representing how a user has consumed audio content, including at least one of content identifiers, playback durations, completion rates, replay counts, and timestamps.

The term “operation history information” refers to structured data representing user operations on a user interface, including at least one of play, pause, skip, seek, like, dislike, or selection actions, together with associated timestamps or content identifiers.

The term “user terminal” refers to an electronic apparatus operated by a user, such as a portable communication apparatus, a wearable apparatus, or a computing apparatus, that is configured to receive data from a server via a digital network, to reproduce audio data, and to transmit user input or feedback to the server.

The term “digital network” refers to a communication infrastructure that transfers digital data between a server and one or more user terminals, including at least one of a local area network, a wide area network, or a public packet-switched network.

In one embodiment, a server, a terminal, and a user cooperate to implement the claimed system. The server includes at least one processor, a main memory, a non-volatile storage device, and a network interface. The terminal includes a processor, a memory, an input interface such as a touch screen, a microphone, or a camera, an audio output interface such as a speaker or headphones, and a network interface. The user operates the terminal to input requests and to consume generated audio content.

The server executes an operating system such as a general-purpose server operating system and executes application programs for information retrieval, natural language processing, emotion analysis, generative text processing, text-to-speech conversion, audio editing, and delivery scheduling. The server stores these programs and configuration data in the non-volatile storage device and loads executable modules into main memory at runtime. The terminal executes an operating system such as a mobile or desktop operating system and executes a client application. The terminal displays user interface elements that allow the user to input textual requests, select topics or categories, optionally specify a desired tone, and consent to emotion analysis. The terminal captures user input as text, and optionally captures audio data via the microphone or image data via the camera. The terminal transmits the captured data to the server via a digital packet-switched network using, for example, an HTTPS protocol.

The server implements an information retrieval unit by executing software that issues search requests to one or more information sources. The server may access external news or document repositories via generic web APIs, such as HTTP-based news aggregation APIs or general search APIs, and may access internal document indices stored in a search engine framework. The server maintains a data structure where each retrieved document is represented as a record containing at least a document identifier, a title string, a body text string, a category label, a publication timestamp, and source metadata. The server stores these records in a database management system such as a relational database or a key-value store. The server implements an analysis unit by executing a natural language processing module. The server loads libraries such as a tokenization and part-of-speech analysis library and an embedding or sequence model library. The server converts user request text and candidate document text into token sequences. The server generates feature vectors for each token and for each entire document or request by applying pre-trained word embeddings or contextual embeddings. The server further applies a classifier model, which may be a neural network or a gradient-boosted decision tree, to infer a topic label and to select salient keywords. The classifier outputs topic information as a compact category code and outputs keyword information as a list of tokens with associated relevance scores.

The server implements emotion state extraction within the analysis unit by processing one or more of audio data, image data, and text data. For audio data, the server computes acoustic features such as Mel-frequency cepstral coefficients, pitch contours, energy statistics, and spectral features. For image data, the server computes visual features such as facial landmark positions, facial expression descriptors, and global color and contrast measures. For text data, the server computes sentiment scores using sentiment analysis models. The server concatenates or aggregates these features into a fixed-length feature vector. The server applies a multi-layer neural network classifier that has an input layer corresponding to the feature vector dimension, at least one hidden layer with a non-linear activation function such as rectified linear unit, and an output layer generating probabilities for emotion categories such as joy, sadness, neutral, anger, or relaxed. During training, the server previously minimized a cross-entropy loss function between predicted emotion probabilities and labeled emotion categories and updated network weights using a stochastic gradient descent algorithm or a variant such as Adam. At runtime, the server applies the trained weights without updating them, and outputs emotion state information including an emotion label and a confidence score.

The server implements history information management by storing user activity logs in a dedicated history database. For each playback event and operation event, the server records user identifier, content identifier, start time, end time, played duration, skip position, and explicit actions such as like or dislike. The server periodically aggregates these logs to compute per-user statistics, such as total listening time per topic, completion rates, typical listening time windows, and reaction frequencies. The server stores these statistics as history information associated with each user.

The server implements a selection unit by combining topic information, keyword information, emotion state information, and history information. The server represents each candidate document as a feature vector including a vectorized topic representation, a vectorized keyword representation, an age feature derived from the publication timestamp, and a similarity measure between document content and past user-preferred content. The server defines a scoring function that computes a correlation score as a weighted sum of topic match, keyword overlap, and semantic similarity; a novelty score as a function of the time elapsed since publication and the number of times the user has already consumed related content; and an emotion suitability score using a model that scores whether a document's sentiment or content type matches the current emotion state. The server may implement the scoring function as a linear or non-linear model, such as a neural ranking model, that has been trained offline by minimizing an error function between predicted engagement and observed engagement using historical data. The server calculates an overall selection score for each candidate document and sorts the documents according to the score. The server discards documents whose overall selection score is below a threshold and retains the top-ranked documents. This specific combination of correlation, novelty, and emotion suitability in the scoring function enables the server to reduce the number of documents that must be processed by the generative AI model and text-to-speech converter, thereby decreasing computational load and network use.

The server implements a generation unit that constructs a prompt sentence for a generative AI model. The server receives selected documents, topic information, keyword information, emotion state information, and history information. The server maps topic information to template phrases describing the subject matter (for example, “technology and artificial intelligence” or “environmental issues”), maps emotion state information to tone specifications (for example, “gentle and encouraging tone” or “informative and neutral tone”), and maps history information to structural parameters, such as preferred summary length and detail level. The server applies a set of deterministic rules to synthesize these elements into a prompt sentence template. For example, the server may generate prompt sentences such as: “Please summarize the following news article in about 200 words for a spoken podcast. Use an informative and slightly positive tone that highlights benefits and opportunities: {article text}”“Please summarize the following news article in a gentle and encouraging tone, focusing on positive aspects and omitting technical jargon: {article text}” “Using the following three news articles about environmental issues, please generate a single podcast script for a general audience. Length: about 800 words. Tone: uplifting but realistic. Articles: {article 1 text} {article 2 text} {article 3 text}”

“Generate a news article that will reinforce a joyful mood. Topic: recent advances in science and technology. Length: about 600 words.”

The server does not merely pass raw text to the generative AI model; instead, the server generates a structured prompt sentence that encodes topic, tone, length, and structure constraints derived from the analysis unit and the selection unit. This explicit parameterization of the prompt sentence results in more predictable and controlled outputs and reduces the number of regeneration attempts required to obtain acceptable content, which improves computational efficiency.

The server implements a generative AI model interface within a text generation unit. The generative AI model may be a transformer-based neural network trained on a large corpus of text data. The neural network includes an embedding layer that maps tokens from the prompt sentence and conditioning article text into continuous vector representations, a plurality of self-attention layers that compute context-dependent representations of tokens, and a final output layer that generates a probability distribution over the vocabulary for each token position. During a prior training phase, the server or an associated training system minimized a language modeling loss, such as cross-entropy between predicted token probabilities and actual tokens in training sequences, and updated the network parameters via back-propagation and gradient-based optimization. At runtime, the server supplies the prompt sentence and article text as a single token sequence and performs autoregressive decoding using beam search or nucleus sampling to produce a summary or a new script. The server sets decoding parameters such as a maximum token count and a temperature value to control diversity. The text generation unit receives the generated text and may perform additional checks, such as verifying that the output length falls within a specified range and that required sections (for example, an introduction and a conclusion) are present.

The server implements an audio conversion unit by integrating a text-to-speech engine. The text-to-speech engine may be configured as a neural vocoder and an acoustic model. The acoustic model converts input text into phoneme sequences and prosodic features, including pitch contours and duration estimates. The neural vocoder converts the acoustic features into a time-domain waveform. The server may configure the text-to-speech engine to use different voice profiles and prosody settings based on emotion state information and history information. For example, for a relaxed evening context, the server may select a slower speaking rate and softer prosody, whereas for a morning commute context, the server may select a more energetic prosody. The server receives the synthesized audio as a digital audio stream and stores the audio as a file in a storage system.

The server implements an editing unit that modifies the audio data. The server processes the audio waveform using a digital signal processing library. The server normalizes levels across segments, applies fades at segment boundaries, and inserts background music and sound effects at specified time offsets. The server maintains a playback structure as a data structure that lists audio segments with associated start times, end times, and mixing parameters, such as volume for each track. The server generates the final mixed audio by rendering this playback structure into a single waveform. By defining the playback structure explicitly and reusing templates that align with user preferences and context, the server shortens editing time and maintains consistent loudness and quality across episodes, which is a technical improvement over naive concatenation.

The server implements a delivery unit that controls the transmission of edited audio to the terminal. The server stores metadata including content identifier, user identifier, estimated duration, topic, and emotion tag. The server cross-references this metadata with history information to determine suitable delivery windows. The server uses a scheduling algorithm that treats time-of-day and day-of-week patterns as features and predicts a probability that the user will engage with the content in each future time interval, for example using a logistic regression or a recurrent neural network trained on historical usage data. The server selects a time interval with a high predicted engagement probability and schedules delivery by creating a job in a job queue. When the scheduled time arrives, the server sends a notification to the terminal and exposes a streaming or download URL. By aligning delivery timing with predicted engagement, the server reduces wasted network transmissions and storage operations for content that would otherwise not be consumed.

The server implements a learning unit that updates processing conditions based on playback history information and operation history information. The server aggregates per-user and global metrics such as average completion rate per topic, skip rates for content generated with certain prompt patterns, and distribution of listening durations. The server adjusts weights in the scoring function of the selection unit, modifies parameter mappings used by the generation unit when creating prompt sentences, and tunes scheduling parameters of the delivery unit. The server may apply an online learning algorithm or a periodic batch learning algorithm that updates model parameters in response to new data. For example, if the server detects that summaries with specific prompt sentence phrases result in higher completion rates, the server increases the probability of using those phrases in future prompts. This creates a feedback loop in which the computer system adapts its internal models and rules to optimize technical metrics such as processing load and successful content utilization rather than simply following a static, hand-coded rule set.

The terminal receives audio content and metadata from the server. The terminal buffers the audio stream or downloads the audio file and plays it using a hardware audio codec and speakers or headphones. The terminal displays the associated text summary or title and user interface components for controlling playback. The terminal logs user operations, including play, pause, seek, skip, and like or dislike, and sends these logs back to the server. The user consumes the content by listening and optionally reading the text summary.

In another embodiment, the server executes multiple generative AI models specialized for different tasks. The server may employ a first generative AI model for fine-grained summarization and a second generative AI model for rewriting content in a conversational podcast style. The generation unit selects which model to invoke based on topic information, emotion state information, and history information. In this embodiment, the server constructs different prompt sentences for each model. For example, the server may generate:

“Summarize the following business news in three concise bullet points for a professional audience: {article text}”

for the first model, and

“Rewrite the following bullet points as a friendly podcast script with a short introduction and a clear conclusion: {bullet points}”

for the second model. The server then assembles the outputs into a final script. This architectural separation allows the system to reduce model size and computation time for each subtask, producing a net reduction in latency.

In another embodiment, the server deploys the analysis unit, selection unit, generation unit, and learning unit as microservices that communicate over internal network protocols. The server defines a shared schema for topic information, keyword information, emotion state information, and history information, and stores this schema in a configuration repository. Each microservice validates incoming data against the schema and logs processing time. The server monitors latency and throughput metrics and dynamically adjusts resource allocation or model complexity. For example, when network and processor load are high, the selection unit may reduce the number of candidate documents passed to the generative AI model by increasing the selection threshold. This lowers the number of generative calls and text-to-speech conversions, which directly reduces processor cycles and network usage.

In yet another embodiment, the terminal performs a portion of the emotion analysis. The terminal extracts low-dimensional features from microphone audio or camera images using lightweight models and transmits only these features rather than raw media data to the server. The server reconstructs emotion state information from the features. This distribution of processing reduces bandwidth requirements and enhances privacy while still enabling the server to compute emotion-sensitive prompt sentences and ranking decisions. The reduction in transmitted data and server-side decoding contributes to improved system-wide throughput and lower network congestion.

By structuring user requests and context into topic information, keyword information, emotion state information, and history information, and by encoding these structures into prompt sentences that guide a generative AI model, the server creates a deterministic and controllable processing pipeline. The server reduces unnecessary generative processing through pre-selection of content, reduces the need for manual curation, and improves the consistency of generated audio quality. Because the server continuously updates internal models based on feedback, the system adapts to changes in user behavior and content availability. These characteristics provide technical effects such as improved processing speed, reduced computational resource consumption, reduced network traffic, improved relevance and suitability of generated audio content, and more stable and predictable operation of generative AI within a computer-implemented information processing system.

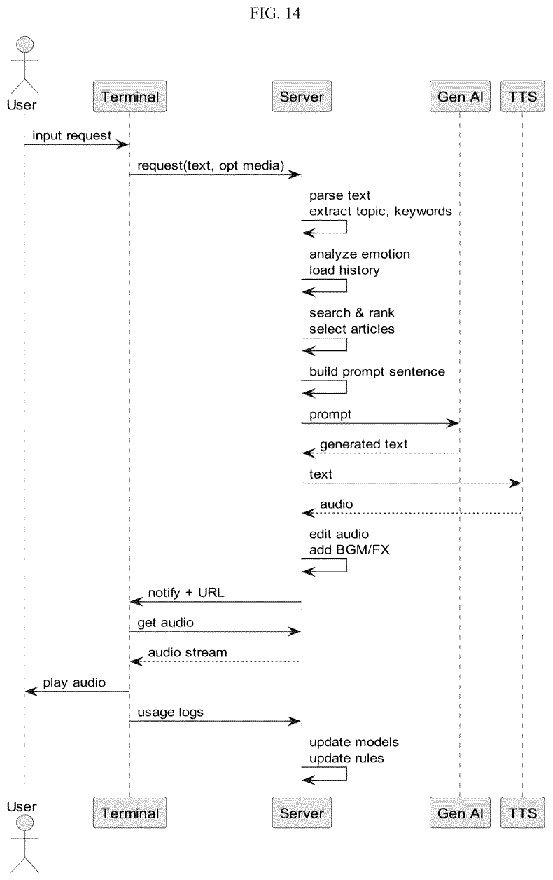

The following describes the processing flow using FIG. 14.

### Step 1

User operates the terminal and inputs a request.

User enters a natural-language request such as “I want the latest technology and AI news in audio form” using a keyboard, touch screen, or voice input on the terminal.

Terminal captures this request as text data and optionally captures audio data from a microphone and image data from a camera if the user has enabled emotion analysis.

Input: raw text, optional raw audio stream, optional raw image frame(s).

Terminal packages these inputs into a structured message including user identifier, timestamp, and device type, and transmits the message to the server via a digital network using an HTTPS protocol.

Output: a structured request message delivered to the server.

### Step 2

Server receives the request and performs initial parsing.

Server accepts the HTTPS request, extracts the text field “request_text,” and stores the raw request and metadata in a log database.

Server invokes a natural language processing module to tokenize the text, normalize case, and remove stop words. Server also performs part-of-speech tagging and basic intent classification.

Input: structured request message containing request_text and metadata.

Server computes a feature vector from the tokenized text and applies an intent classifier to determine whether the user is asking for latest news, a summary, or a generated script, and extracts preliminary keywords.

Output: parsed request data including intent type, preliminary keyword list, and associated metadata.

### Step 3

Server analyzes topic information and keyword information.

Server passes the parsed text to a topic classification model implemented in software.

Server converts the token sequence into embedding vectors and inputs these vectors into a trained classifier to infer a topic category such as “technology,” “environment,” or “business.”

Input: tokenized text and feature vector derived from the user request.

Server computes classification scores for each possible topic and selects the topic with the highest score as topic information; server refines the keyword list by selecting tokens with high term-frequency-inverse-document-frequency values or high attention weights.

Output: topic information and refined keyword information associated with the user request.

### Step 4

Server determines emotion state information.

If audio data or image data is present in the request, server extracts acoustic and visual features.

Server computes Mel-frequency cepstral coefficients, energy, and pitch statistics from the audio, and extracts facial landmarks and expression descriptors from the image.

Input: raw audio data and/or raw image data from the terminal, or text data when only sentiment analysis is available.

Server concatenates these features into a feature vector and feeds it into an emotion classification neural network, which outputs emotion probabilities. Server selects the emotion label with maximum probability and records it as emotion state information with a confidence score.

Output: emotion state information indicating the current emotional category of the user and its confidence.

### Step 5

Server retrieves and aggregates history information.

Server queries a history database using the user identifier to obtain past playback records and operation records.

Server loads entries such as previously listened content identifiers, timestamps, content categories, completion rates, skip events, and explicit likes or dislikes.

Input: user identifier and a time range for history retrieval.

Server aggregates these records using statistical functions to compute per-topic listening times, typical listening time windows, and preference scores for each content category.

Output: history information containing preference scores and time-of-use patterns associated with the user.

### Step 6

Server retrieves candidate information via the information retrieval unit.

Server constructs a search query string by combining the topic information and keyword information, and may adjust the query based on emotion state information (for example, adding “positive” or “encouraging”).

Server sends the query to external search interfaces or internal search indices and receives responses containing lists of documents or news items.

Input: topic information, keyword information, and optional emotion-based modifiers.

Server parses the search responses, converts each item into an internal record with fields for title, body text, category, publication time, and source, and stores these candidate records in temporary storage.

Output: a set of candidate information items available for further processing.

### Step 7

Server selects and ranks candidate information using the selection unit.

Server computes feature values for each candidate item, including similarity to the user request, similarity to past preferred content, time since publication, and sentiment indicators.

Server applies a scoring function that combines a correlation component, a novelty component, and an emotion suitability component into a single selection score.

Input: candidate item records, topic information, keyword information, emotion state information, and history information.

Server calculates the selection score for each item, sorts the items by score in descending order, filters out items below a threshold, and retains the top-ranked items as selected information.

Output: an ordered list of selected information items to be used as input for generative processing.

### Step 8

Server constructs a prompt sentence for a generative AI model.

Server reads the selected information list and assembles one or more source texts, such as a full article body or multiple article summaries.

Server determines prompt parameters, including desired output length, tone, and structure, based on topic information, emotion state information, and history information (for example, concise summaries for short sessions, longer scripts for long commuting windows).

Input: selected information items, topic information, emotion state information, and history information.

Server applies template rules to build a prompt sentence such as:

“Please summarize the following news article in about 200 words for a spoken podcast. Use an informative and slightly positive tone that highlights benefits and opportunities: {article text}”

or

“Using the following three news articles about environmental issues, please generate a single podcast script for a general audience. Length: about 800 words. Tone: uplifting but realistic. Articles: {article 1 text} {article 2 text} {article 3 text}”

Output: one or more prompt sentences containing explicit instructions and embedded source text for the generative AI model.

### Step 9

Server generates text using the generative AI model.

Server sends the prompt sentence and embedded text to a generative AI model interface, specifying generation parameters such as maximum token count and temperature.

Server receives token-by-token output from the generative AI model and reconstructs the generated text.

Input: prompt sentence and generation parameters.

Server checks the generated text for compliance with requested length and structure, trims or adjusts the output if necessary, and stores the generated summary or script as text data associated with the selected information and user.

Output: generated text data in the form of a summary, article, or podcast script.

### Step 10

Server converts generated text into audio data using the audio conversion unit.

Server sends the generated text to a text-to-speech engine along with configuration parameters such as language, voice type, speaking rate, and prosody that may be selected based on emotion state information and history information.

Server receives a synthesized audio stream or file representing the spoken form of the generated text.

Input: generated text data and voice configuration parameters.

Server encodes the audio stream into a compressed format and stores the audio file in a storage subsystem, recording a reference to this file in a content database.

Output: raw audio data file corresponding to the generated text.

### Step 11

Server edits the audio using the editing unit.

Server loads the raw audio file and any predefined intro music or sound effects.

Server constructs a playback structure describing the order and timing of each segment, including the spoken content and background audio, and determines volume levels and fade-in/fade-out parameters.

Input: raw audio data, background audio assets, and playback structure parameters.

Server applies digital signal processing to mix tracks, normalize loudness, insert transitions, and render the final audio waveform, then stores the edited audio file for delivery.

Output: edited audio data ready for transmission to the terminal.

### Step 12

Server schedules and performs delivery using the delivery unit.

Server evaluates history information to identify preferred listening windows and combines this information with current emotion state information to select an appropriate delivery time.

Server creates a delivery job including the edited audio file reference, user identifier, and scheduled time, and inserts the job into a scheduling queue.

Input: edited audio data reference, emotion state information, and history information.

When the scheduled time is reached, server retrieves the job, generates a streaming URL or download URL for the audio file, and sends a notification to the terminal indicating that new content is available.

Output: a delivered URL and metadata sent to the terminal, and an audio delivery event recorded in server logs.

### Step 13

Terminal receives the notification and retrieves audio content.

Terminal accepts the incoming notification from the server and extracts content metadata and the URL.

Terminal establishes an HTTPS connection to the server or a content distribution node and requests the audio stream or file.

Input: notification containing audio URL and metadata.

Terminal buffers the received audio data, initiates playback through its audio output interface, and displays associated text information such as title and summary.

Output: audio playback to the user and a local record of the playback session.

### Step 14

User consumes the content and interacts with the player.

User listens to the audio content through the terminal's speaker or connected headphones.

User may pause, resume, skip forward, seek within the content, or indicate a like or dislike using the terminal interface.

Input: audio playback and user controls on the terminal interface.

Terminal records user actions and playback progress, generating operation history and playback history entries which are stored temporarily on the terminal for later upload.

Output: local logs of playback history information and operation history information.

### Step 15

Terminal uploads usage logs to the server.

Terminal batches the recorded playback history and operation history and transmits them to the server at predetermined intervals or when a network connection is available.

Input: local log records describing content identifier, playback duration, completion status, and user actions.

Terminal sends the logs in a structured format to a logging endpoint on the server, ensuring reliable delivery with retransmission if necessary.

Output: log data successfully transferred to the server for analysis.

Step 16

Server updates models and processing conditions using the learning unit.

Server receives the uploaded playback history information and operation history information and stores them in the history database.

Server aggregates the new logs with existing data to update metrics such as completion rates, skip rates, and like/dislike ratios for each content type, prompt pattern, and delivery time window.

Input: newly received history logs and previously stored history information.

Server adjusts parameters of the scoring function in the selection unit, modifies rules and templates in the generation unit for building prompt sentences, and updates scheduling parameters in the delivery unit. These updates may be performed by recalculating weights in statistical models or retraining machine learning models using the expanded dataset.

Output: updated processing conditions and model parameters that influence subsequent analysis, selection, prompt construction, and delivery, thereby closing the feedback loop and improving system performance over time.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

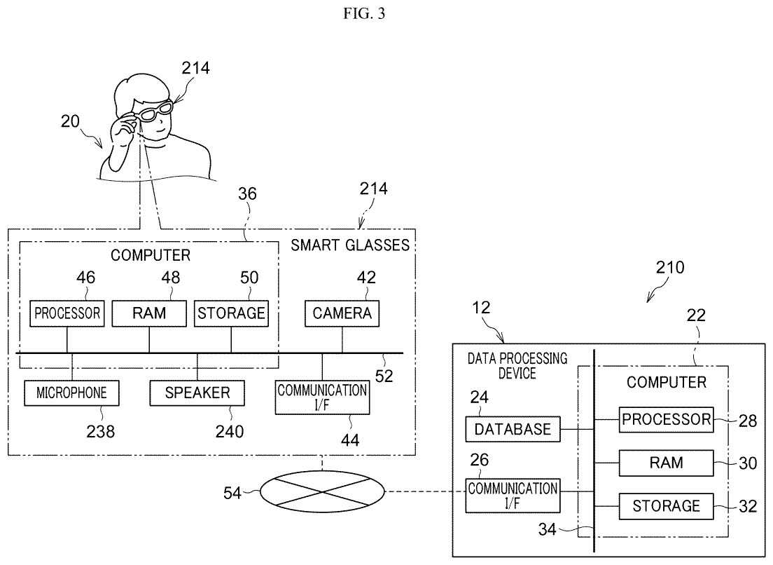

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

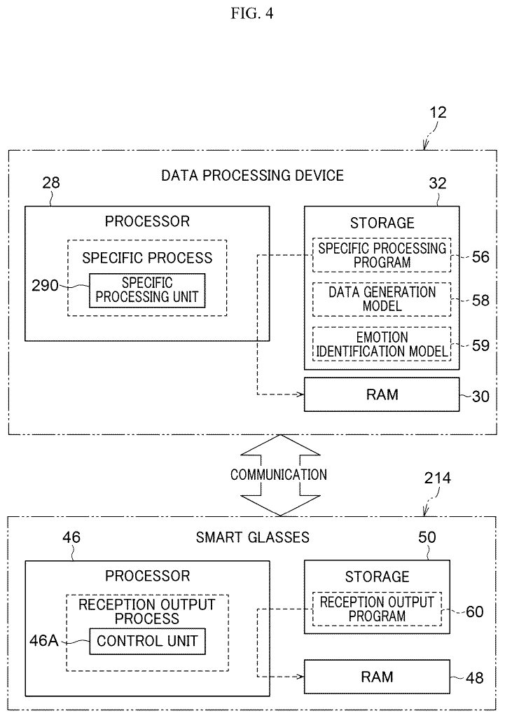

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

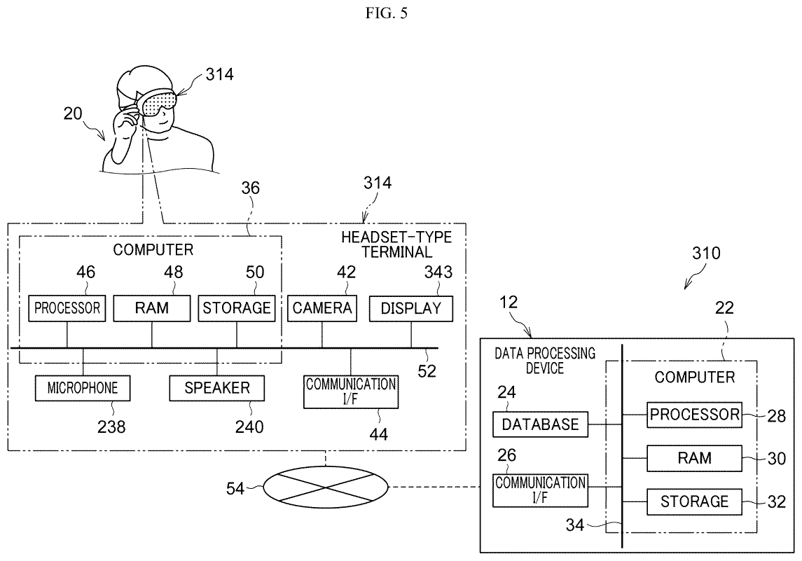

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

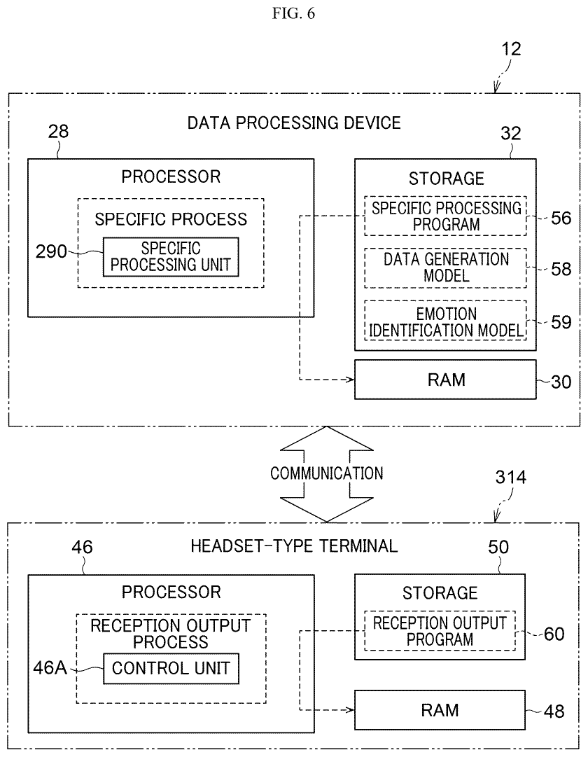

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

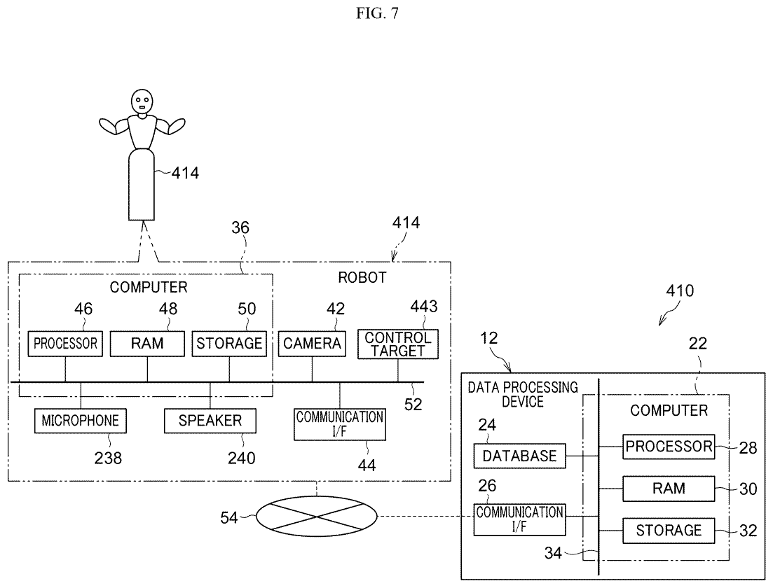

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

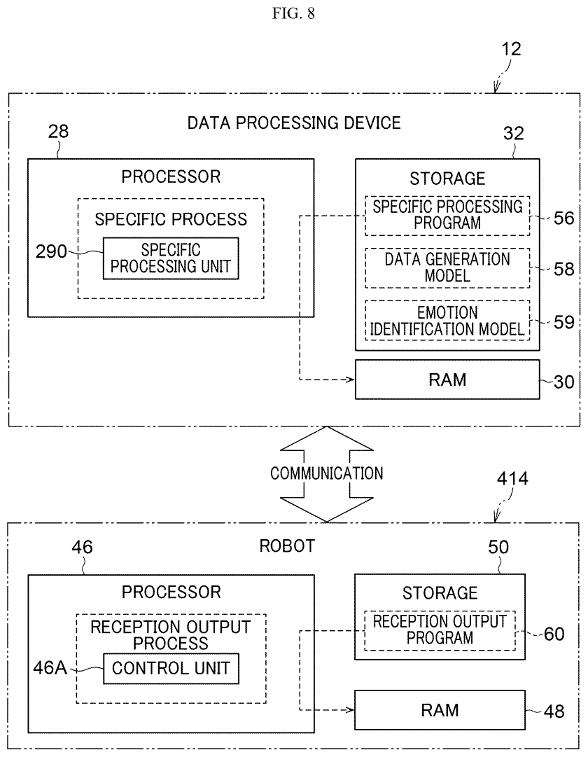

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

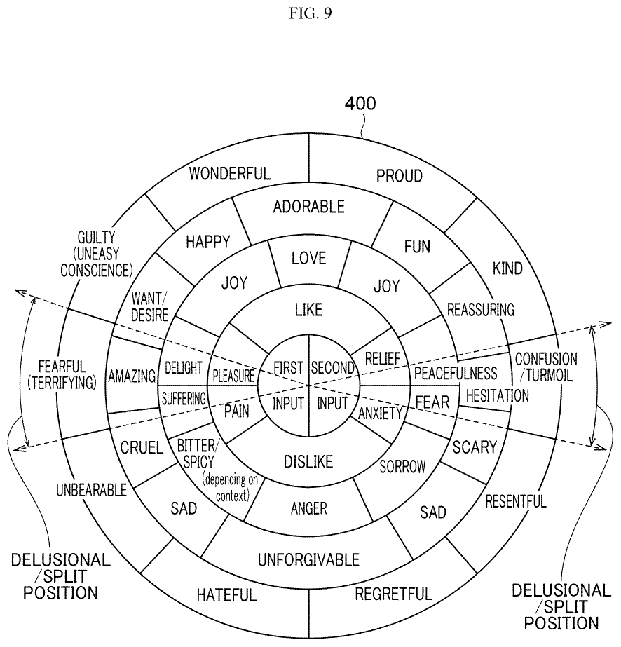

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

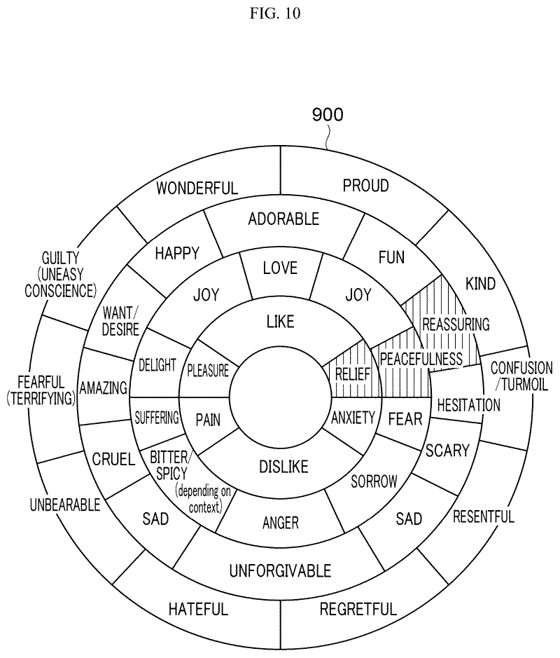

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### Supplementary 1

A system comprising a processor,
wherein the processor is configured to
acquire request information based on an operation of a user via a communication network and generate search condition information including the request information,
transmit a search request to an external information providing apparatus based on the search condition information, receive document information from the external information providing apparatus, and analyze the document information to extract article information,
generate, based on the article information and audio output condition information, a prompt sentence that instructs a generative AI model to convert the article information into script information for audio data, and input the prompt sentence and the article information into the generative AI model to cause the generative AI model to generate the script information,
instruct an audio synthesis apparatus to generate audio data based on the script information and audio synthesis condition information, and input the script information into the audio synthesis apparatus to cause the audio synthesis apparatus to generate narration audio data,
obtain the narration audio data and background sound data and sound effect data stored in advance, and generate edited audio data by combining the background sound data and the sound effect data with the narration audio data based on time information and volume information, and
store the edited audio data in a storage apparatus and provide the edited audio data stored in the storage apparatus to a utilization terminal apparatus in at least one of a streaming distribution format and a download distribution format.

### Supplementary 2

The system according to supplementary 1,
wherein the processor is configured to cause the generative AI model to summarize a plurality of pieces of document information acquired from the external information providing apparatus, generate the script information divided into a plurality of sections in accordance with configuration conditions included in the prompt sentence, and output instruction information indicating insertion positions of the background sound data or the sound effect data between the sections.

### Supplementary 3

The system according to supplementary 1,
wherein the processor is configured, in generating the edited audio data, to determine start times and end times of the background sound data and the sound effect data based on the time information of the narration audio data and the instruction information, set a volume of the background sound data lower than a volume of the narration audio data, and perform fade-in processing and fade-out processing by changing the volume of the background sound data over a predetermined time period.

### Application Example 1

### Supplementary 1

A system comprising a processor,
wherein the processor is configured to
acquire topic information transmitted from a terminal based on an operation of a user, generate search conditions based on the topic information, execute an information retrieval process according to the search conditions, and extract text data from a plurality of document data acquired via a network,
generate a prompt sentence, which defines contents, narrative style, structure, and amount of generation processing, on the basis of the extracted text data and the topic information, input the prompt sentence and the text data into a generative information processing model, and cause the generative information processing model to generate script text for audio output,
convert the script text into an audio signal by using a speech synthesis technique,
perform editing processing including adjustment of sound volume level, adjustment of time length, superimposition, and section-by-section concatenation, on the basis of the audio signal and a plurality of acoustic material data stored in a storage device, and generate edited audio data to which background sound and sound effects are added,
add identification information and description information to the edited audio data, register the edited audio data as distribution content, and generate response data including location information of the distribution content, and
stream-distribute or download-distribute the edited audio data to the terminal via a digital communication path on the basis of the response data.

### Supplementary 2

The system according to supplementary 1,
wherein the processor is configured to
variably generate the prompt sentence to be input to the generative information processing model according to language information specified by the user, playback time information, and setting information regarding presence or absence of background sound, and perform processing of summarizing or detailing the script text so that a length of the script text corresponds to the playback time information.

### Supplementary 3

The system according to supplementary 1,
wherein the processor is configured to
register the edited audio data in a content delivery infrastructure managed by a distribution management apparatus, and perform progressive delivery in response to a playback request from the terminal by using a distribution control interface provided by the content delivery infrastructure.

### Example 2

### Supplementary 1

A system comprising a processor,
wherein the processor is configured to
receive, from a terminal operated by a user, classification information and search terms via an input unit,
acquire, from a storage device, usage history information corresponding to user identification information included in the received classification information and search terms, and analyze the usage history information to generate attribute information representing an interest tendency of the user by applying at least one of statistical processing and machine learning processing,
acquire, from an external information source, related information corresponding to the classification information and the search terms, and select and organize the related information based on the attribute information by ranking multiple information items according to a degree of relevance to a user profile,
construct a prompt sentence, as a content generation instruction, for a generative AI model, the prompt sentence including content generation conditions that vary for each user and including at least one of a target content amount, a writing style, and a focus topic, and further including context information comprising summaries of higher-ranked information items and descriptive information of the user profile,
input the constructed prompt sentence into the generative AI model to cause the generative AI model to perform natural language processing and generate, based on the related information and the attribute information, text data or script data for audio content in which the related information is summarized and restructured,
convert the generated text data into audio data by using a speech synthesis technique, and add at least one of sound effect information and music information to the audio data to generate edited audio data, and
deliver at least one of the generated text data and the edited audio data to the terminal via a digital communication path.

### Supplementary 2

The system according to supplementary 1,
wherein the processor is configured to
generate, from the usage history information, the user profile indicating at least a preference for a topic category, a preference for a content length, and a preference for a medium type, and to include, in the prompt sentence, condition information specifying at least one of an amount of content to be generated, a style of expression, and a focus topic, based on the user profile.

### Supplementary 3

The system according to supplementary 1,
wherein the processor is configured to
obtain, as the related information, a plurality of information items corresponding to the classification information and the search terms, rank the plurality of information items according to a relevance to the user profile generated from the usage history information, and include summaries of higher-ranked information items as contextual information in the prompt sentence so as to cause the generative AI model to generate news content that differs for each user.

### Application Example 2

### Supplementary 1

A system comprising a processor,
wherein the processor is configured to
acquire information in response to a user request by using an information retrieval unit,
analyze text data based on the user request to extract topic information, keyword information, emotion state information, and history information by using an analysis unit,
evaluate correlation, novelty, and emotion suitability of the acquired information based on the topic information, the keyword information, the emotion state information, and the history information, and select and rank the acquired information by using a selection unit,
generate a prompt sentence that instructs a generative AI model to perform summarization or content generation, by using the information selected by the selection unit as input information, by using a generation unit,
input the prompt sentence into the generative AI model and obtain text data output from the generative AI model by using a text generation unit,
convert the text data obtained by the text generation unit into audio data by using an audio conversion unit,
add background sound, music, or sound effects to the audio data generated by the audio conversion unit and edit a playback structure of the audio data by using an editing unit,
transmit the edited audio data to a user terminal via a digital network and optimize delivery timing based on the emotion state information and the history information by using a delivery unit, and
update processing conditions of the analysis unit, the selection unit, and the generation unit based on playback history information and operation history information acquired from the user terminal by using a learning unit.

### Supplementary 2

The system according to supplementary 1,
wherein the processor is configured to
perform emotion analysis on audio data, image data, or text data acquired from the user terminal by using the analysis unit, generate emotion classification information, and control tone, style, and summary length of the prompt sentence by the generation unit in accordance with the emotion classification information.

### Supplementary 3

The system according to supplementary 1,
wherein the processor is configured to
calculate, by using the learning unit, a content preference degree and a time-of-use tendency for each user based on the playback history information and the operation history information, and automatically adjust ranking of the information by the selection unit and delivery timing of the audio data by the delivery unit.

What is claimed is:

1. A system comprising:
circuitry configured to:
receive, via a communication interface coupled to a packet-switched network, input data from a terminal device;
generate query data based on the input data and transmit the query data to an information providing apparatus via the packet-switched network;
receive document data from the information providing apparatus, and extract text data from the document data;
generate an instruction sequence based on the text data and input the instruction sequence into a generative neural network model to cause the generative neural network model to generate structured output data, the structured output data including position information indicating insertion locations for supplementary signal segments;
convert the structured output data into first signal data by synthesis processing and acquire time information associated with the first signal data; and
generate edited signal data by combining the first signal data with a plurality of supplementary signal segments retrieved from a storage device based on the time information, the position information, and amplitude parameters defining volume relationships between the first signal data and each supplementary signal segment, and transmit the edited signal data to the terminal device via the communication interface.

2. The system according to claim 1, wherein the circuitry is further configured to analyze the input data by speech recognition processing to convert audio input from the terminal device into text-form request data, and generate the query data based on the text-form request data.

3. The system according to claim 2, wherein the circuitry is further configured to generate search condition information from the text-form request data, the search condition information including at least a query string, a language restriction parameter, and a recency filter, and transmit the search condition information to the information providing apparatus as the query data.

4. The system according to claim 3, wherein the circuitry is further configured to receive a plurality of document data items from the information providing apparatus, apply a parsing operation to each document data item to remove non-content regions and extract article information including a title string and a body text string, and select a subset of the article information based on a relevance score computed from term frequency of the query string within each body text string.

5. The system according to claim 4, wherein the instruction sequence includes a task description specifying a narrative structure for the structured output data, configuration conditions defining a number of sections and an ordering of content, and explicit formatting markers that instruct the generative neural network model to output the position information as machine-parseable tags indicating insertion locations for the supplementary signal segments between the sections.

6. The system according to claim 1, wherein the synthesis processing includes a text-to-speech conversion that converts the structured output data into the first signal data by generating phoneme sequences from the structured output data and producing waveform samples from the phoneme sequences using a neural vocoder model.

7. The system according to claim 6, wherein the circuitry is further configured to acquire alignment data from the synthesis processing, the alignment data indicating word-level or sentence-level timestamps within the first signal data, and determine start times and end times for each supplementary signal segment based on the alignment data and the position information.

8. The system according to claim 7, wherein the circuitry is further configured to set the amplitude parameters such that a volume level of each supplementary signal segment is lower than a volume level of the first signal data during overlapping time intervals, and apply fade-in processing and fade-out processing to each supplementary signal segment by varying the amplitude parameters over a predetermined time period at a beginning and an end of each supplementary signal segment.

9. The system according to claim 1, wherein the circuitry is further configured to acquire, from the storage device, usage history information corresponding to a user identifier associated with the input data, and analyze the usage history information to generate a user profile indicating at least a preference for topic categories and a preference for content length.

10. The system according to claim 9, wherein the circuitry is further configured to rank a plurality of text data items extracted from the document data according to a composite relevance score computed from a similarity between topic attributes of each text data item and the preference for topic categories in the user profile, and select higher-ranked text data items for inclusion in the instruction sequence.

11. The system according to claim 10, wherein the circuitry is further configured to include, in the instruction sequence, content generation conditions that vary for each user based on the user profile, the content generation conditions specifying at least one of a target output length, a writing style parameter, and a focus topic derived from the preference for topic categories.

12. The system according to claim 1, wherein the circuitry is further configured to store the edited signal data in the storage device and generate a resource locator associated with the edited signal data, and transmit the edited signal data to the terminal device in at least one of a streaming distribution format in which playback begins before all of the edited signal data is received and a download distribution format in which the edited signal data is transferred to the terminal device before playback.

13. The system according to claim 12, wherein the circuitry is further configured to add identification information and description information to the edited signal data, register the edited signal data with the identification information and the description information as distribution content in a content delivery infrastructure, and generate response data including location information of the distribution content for transmission to the terminal device.

14. The system according to claim 1, wherein the circuitry is further configured to acquire emotion data by analyzing at least one of audio data from an acoustic acquisition device of the terminal device and image data from an imaging device of the terminal device, and determine emotion state information indicating a current emotional category of a user based on the emotion data.

15. The system according to claim 14, wherein the circuitry is further configured to set tone and style parameters of the instruction sequence in accordance with the emotion state information, and optimize delivery timing of the edited signal data to the terminal device based on the emotion state information and history information acquired from the terminal device.

16. The system according to claim 1, wherein the circuitry is further configured to acquire playback history information and operation history information from the terminal device, and update processing conditions of at least one of the extraction of the text data, the generation of the instruction sequence, and the combining of the first signal data with the plurality of supplementary signal segments based on the playback history information and the operation history information.

17. The system according to claim 16, wherein the structured output data is a podcast script for audio news content divided into a plurality of narration sections, the supplementary signal segments include background music data and sound effect data, and the edited signal data is an audio news program in which the background music data and the sound effect data are temporally aligned with the narration sections for delivery to the terminal device in an eyes-busy or hands-busy usage scenario.

18. A system comprising:
circuitry configured to:
receive, via a communication interface coupled to a packet-switched network, topic information and preference parameters from a terminal device operated by a user;
generate search condition information based on the topic information including at least a query string and a language restriction, and transmit the search condition information to an external information providing apparatus via the packet-switched network to acquire a plurality of document data items;
extract text data from the plurality of document data items by a parsing operation that removes non-content regions and normalizes character encoding, and select a subset of the text data based on a relevance score;
construct a prompt sentence that defines contents, narrative style, structure, and output length based on the text data and the topic information, and input the prompt sentence and the text data into a transformer-based generative neural network model to cause the transformer-based generative neural network model to generate script information divided into a plurality of sections together with instruction information indicating insertion positions for supplementary signal segments;
convert the script information into narration signal data by a speech synthesis technique that generates phoneme sequences and produces waveform samples, and acquire alignment data indicating temporal positions within the narration signal data; and
retrieve, from a storage device, background signal data and effect signal data corresponding to the instruction information, generate edited signal data by combining the narration signal data with the background signal data and the effect signal data based on the alignment data, the insertion positions, and volume parameters that set the background signal data at a lower amplitude than the narration signal data, and transmit the edited signal data to the terminal device via the communication interface.

19. The system according to claim 18, wherein the circuitry is further configured to variably generate the prompt sentence according to language information, playback time information, and setting information regarding presence or absence of background signal data specified by the user via the terminal device, and adjust a length of the script information so that an estimated playback duration of the narration signal data corresponds to the playback time information.

20. A method performed by circuitry of a server coupled to a packet-switched network via a communication interface, the method comprising:
receiving, via the communication interface, input data from a terminal device;
generating query data based on the input data and transmitting the query data to an information providing apparatus via the packet-switched network;
receiving document data from the information providing apparatus, and extracting text data from the document data;
generating an instruction sequence based on the text data and inputting the instruction sequence into a generative neural network model to cause the generative neural network model to generate structured output data, the structured output data including position information indicating insertion locations for supplementary signal segments;
converting the structured output data into first signal data by synthesis processing and acquiring time information associated with the first signal data; and
generating edited signal data by combining the first signal data with a plurality of supplementary signal segments retrieved from a storage device based on the time information, the position information, and amplitude parameters defining volume relationships between the first signal data and each supplementary signal segment, and transmitting the edited signal data to the terminal device via the communication interface.
